(19) United States
(12) Patent Application Publication
(10) Pub. No.: US 2008/0318774 A1
(43) Pub. Date: Dec. 25, 2008

(54) SUSPENSION OF ACTIVE COMPOUNDS IN GLYCEROL

(75) Inventors: Smita Patel, Eppstein-Bremthal (DE); Joachim Baumgartner, Frankfurt a. M. (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Bayer CropScience AG, Monheim (DE)

(21) Appl. No.: 12/142,638

(22) Filed: Jun. 19, 2008

(30) Foreign Application Priority Data
Jun. 20, 2007 (EP) 07 012 075.2

(51) Int. Cl. A01N 25/32

(52) U.S. Cl. 504/103

(57) ABSTRACT

The present invention relates to active compound suspensions comprising at least 60% by weight of glycerol, agrochemically active compounds, wetting agents, dispersants and antifoams, and also optionally agents for adjusting rheological properties, acids for adjusting the pH, preservatives and further components, such as formulation auxiliaries, surfactants and solvents. The active compound suspensions and the agrochemical compositions obtainable therefrom can be used for controlling harmful organisms.

The invention relates to the field of chemical crop protection, in particular to the use of particular suspension concentrates of agrochemically active compounds, and also to agrochemical compositions comprising these suspension concentrates.

In general, agrochemically active compounds for crop protection are not employed in pure form. Depending on the area of use and the type of use, and on physical, chemical and biological parameters, the active compound is used as an active compound formulation in a mixture with customary auxiliaries and additives. However, the active compound formulation of combinations (mixtures) with further active compounds for widening the activity spectrum and/or for protecting the crop plants, for example by safeners (antidotes), is an important field of formulation technology, since active compounds having in some cases quite different physical, chemical and biological parameters have to be formulated together in an adequate manner here.

Formulations of individual active compounds, like formulations of combinations of a plurality of active compounds for crop protection, should generally be easy to apply and easy to use and have broad biological action combined with high selectivity with respect to the active compounds used, and should additionally be easy to formulate in the preparation process. Of particular importance here is in particular high chemical and physical stability (storage stability) of the formulation.

Suitable formulations, which allow the demands mentioned above for use in crop protection to be met, are concentrated suspensions (active compound suspensions) in which the active compound particles (discontinuous phase) are suspended in an external liquid phase (continuous phase). Depending on the nature of the external phase, the suspensions are classified as suspension concentrates (short names according to GCPF code, formerly GIFAP code: SC), where the main component of the external phase is water, or in oil dispersions (code: OD), where the main component of the external phase is an organic solvent. The choice of the respective external phase is frequently determined by the stability of the active compounds in question. In general, active compounds which are unstable in water are formulated as OD, and active compounds which are unstable in organic solvents are formulated as SC. However, in addition, there are also active compounds which can be formulated in a stable manner neither in water nor in customary organic solvents. For formulations of this type of active compounds, in particular in combination with further active compounds having in each case a different stability in the external phase, there are currently no convincing solutions.

This also includes attempts to replace the customary solvents of the external phase by other liquids. Thus, US 2002/0065198 A1 uses, as liquid for the external phase, glycol (1,2-propanediol) in concentrations of 20-80% by weight in combination with a particular nonionic surfactant.

Accordingly, it is an object of the invention to provide a suitable liquid for the external phase of active compound suspensions, which allows an advantageous formulation of agrochemically active compounds, individually as well as in combination, in particular with a view to the storage stability of all active compounds.

Surprisingly, it has now been found that this object is achieved by the active compound suspensions of the present invention.

The invention provides an active compound suspension, comprising:
(a) at least 60% by weight of glycerol,
(b) one or more agrochemically active compounds,
(c) one or more wetting agents,
(d) one or more dispersants,
(e) one or more antifoams,
and
(f) optionally one or more agents for adjusting rheological properties,
(g) optionally acids for adjusting the pH to from 2.5 to 4.5,
(h) optionally preservatives (biocides),
(i) optionally further formulation auxiliaries,
(j) optionally further surfactants,
(k) optionally further solvents.

Hereinbelow, the statement “% by weight” (percent by weight) in the entire description, unless defined otherwise, refers to the relative weight of the component in question, based on the total weight of the formulation.

In a preferred embodiment, these active compound suspensions comprise
(a) from 60 to 90% by weight, preferably from 70 to 85% by weight, of glycerol,
(b) from 0.1 to 30% by weight, preferably from 5 to 20% by weight, of agrochemically active compounds,
(c) from 0.1 to 20% by weight, preferably from 1 to 5% by weight, of wetting agents,
(d) from 0.1 to 20% by weight, preferably from 1 to 5% by weight, of dispersants,
(e) from 0.02 to 2% by weight, preferably from 0.2 to 1.5% by weight, of antifoams,
(f) from 0 to 7% by weight, preferably from 0.1 to 4% by weight, of agents for adjusting rheological properties,
(g) from 0 to 3% by weight, preferably from 0.3 to 1.5% by weight, of acids for adjusting the pH to from 2.5 to 4.5,
(h) from 0 to 1% by weight, preferably from 0.05 to 0.4% by weight, of preservatives (biocides),
(i) from 0 to 30% by weight, preferably from 5 to 15% by weight, of further formulation auxiliaries,
(j) from 0 to 10% by weight of further surfactants,
(k) from 0 to 30% by weight, preferably from 0 to 20% by weight, particularly preferably from 0 to 13% by weight, of further solvents.

A particularly preferred embodiment are active compound suspensions according to the invention comprising
(a) from 65 to 85% by weight of glycerol,
(b) from 0.1 to 2% by weight of sulfonamide herbicide, preferably thiencarbazone(-methyl),
(b) from 1 to 10% by weight of herbicide, preferably tembotrione,
(b) from 0.5 to 8% by weight of safener, preferably isoxadifen-ethyl,
(b) from 0.5 to 8% by weight of safener, preferably cyprosulfamide,
(c) from 0.1 to 8% by weight of wetting agent, preferably ®Monatrope 1620 (AL2575),
(d) from 0.3 to 15% by weight of dispersant, preferably ®Dispersogen LFH,
(e) from 0.1 to 2% by weight of antifoam, preferably ®Rhodorsil 481,
(f) from 0.05 to 3% by weight of an agent for adjusting rheological properties, preferably ®Rhodopol 23,
(f) from 0.05 to 3% by weight of an agent for adjusting rheological properties, preferably ®Aerosil 200,
(g) from 0 to 2% by weight of acids for adjusting the pH to from 2.5 to 4.5, preferably citric acid,
(h) from 0 to 1% by weight of preservatives (biocides), preferably ®Proxel GXL,
(i) from 2 to 10% by weight of further formulation auxiliaries, preferably ammonium sulfate (technical grade),
(k) from 0 to 13% by weight of further solvents, preferably water (deionized).

A further particularly preferred embodiment are active compound suspensions according to the invention comprising
(a) from 75 to 90% by weight of glycerol,
(b) from 0.5 to 3% by weight of sulfonamide herbicide, preferably thiencarbazone(-methyl),
(b) from 1 to 10% by weight of herbicide, preferably isoxaflutole,
(b) from 0.5 to 10% by weight of safener, preferably cyprosulfamide,
(c) from 0.1 to 8% by weight of wetting agent, preferably ®Atlox 4894,
(d) from 0.3 to 15% by weight of dispersant, preferably ®Atlox 4913,
(e) from 0 to 2% by weight of antifoam, preferably ®Rhodorsil 481,
(f) from 0 to 7% by weight of an agent for adjusting rheological properties, preferably ®Kaolin W,
(g) from 0 to 2% by weight of acids for adjusting the pH to from 2.5 to 4.5, preferably citric acid,
(h) from 0 to 1% by weight of preservatives (biocides), preferably ®Proxel GXL,
(h) from 0 to 1% by weight of preservatives (biocides), preferably ®Acticide MBS,
(k) from 0 to 13% by weight of further solvents, preferably water (deionized).

For glycerol (1,2,3-propanetriol) as component a) in the formulations according to the invention, it is possible to use all forms and sources known to the person skilled in the art, for example from Brenntag, Baerlocher, Fauth Chemie and Riedel de Häen.

According to the invention, glycerol of any purity and concentration may be used.

The amount of glycerol in the formulations according to the invention (component a) may be from 60 to 90% by weight, preferably from 70 to 85% by weight.

Suitable agrochemically active compounds (component b) are all active compounds which, owing to their nature, can be formulated in the active compound suspensions according to the invention, i.e. either on their own or in combination as active compound particles in the discontinuous phase having a mean particle diameter of 1-5 micron (d50=1-5μ) and/or liquid as combination partners in the external liquid phase (continuous phase).

Preferred as agrochemically active compounds (component b) are all active compounds from the group of the herbicides and/or safeners which are biologically active against weeds in the wider sense, hereinbelow also referred to as harmful plants, whereas safeners protect or invigorate crop plants, and/or from the group of the insecticides and fungicides, which are biologically active against insects, arachnids and nematodes or fungi and bacteria in the wider sense, hereinbelow also referred to as harmful animals and phytopathogenic microorganisms (harmful fungi). Hereinbelow, harmful plants, harmful animals and harmful fungi together are also referred to as harmful organisms.

Active compounds from the group of the herbicides, also comprising plant growth regulators, and safeners; from the group of the insecticides, also comprising acaricides, nematicides, molluscicides, rodenticides, repellents; and from the group of the fungicides, also comprising bactericides and viricides, and also plant nutrients may be mentioned as being preferred. Hereinbelow, the term herbicides comprises both herbicides and plant growth regulators, the term insecticides comprises both insecticides and acaricides, nematicides, molluscicides, rodenticides and repellents, and the term fungicides comprises both fungicides and bactericides and viricides—unless the context indicates otherwise. Examples of individual agrochemically active compounds from the groups mentioned above are:

Herbicides

Examples of herbicides are, for example, known active compounds which are based on inhibition of, for example, acetolactate synthase, acetyl-coenzyme A carboxylase, PS I, PS II, HPPDO, phytoene desaturase, protoporphyrinogen oxidase, glutamine synthetase, cellulose biosynthesis, 5-enolpyruvylshikimate 3-phosphate synthetase. Such compounds, and also other usable compounds, with a mechanism of action that is, in some cases, unknown or different, are described, for example, in Weed Research 26, 441-445 (1986), or in the handbook “The Pesticide Manual”, 12th edition 2000, or 13th edition 2003 or 14th edition 2006/2007, or in the corresponding “e-Pesticide Manual”, Version 4 (2006), published in each case by the British Crop Protection Council, (hereinafter also abbreviated to “PM”), and the literature cited therein. Lists of common names are also available in the Internet in “The Compendium of Pesticide Common Names”. Herbicides which are known from the literature which can be combined with the compounds of the formula (I) include, for example, the following active compounds (note: the compounds, herbicides as well as safeners, are referred to either by the common name in accordance with the International Organization for Standardization (ISO) or by the chemical names, if appropriate together with a customary code number): acetochlor; acibenzolar-S-methyl; acifluorfen(-sodium); aclonifen; AD-67; AKH 7088, i.e. [[[1-[5-[2-chloro-4-(trifluoromethyl)phenoxy]-2-nitrophenyl]-2-methoxyethylidene]amino]oxy]acetic acid and its methyl ester; alachlor; alloxydim(-sodium); ametryn; amicarbazone, amidochlor, amidosulfuron; aminopyralid; amitrol; AMS, i.e. ammonium sulfamate; ancimidol; anilofos; asulam; atrazin; aviglycine; azafenidin, azimsulfuron (DPX-A8947); aziprotryn; barban; BAS 516 H, i.e. 5-fluoro-2-phenyl-4H-3,1-benzoxazin-4-one; beflubutamid, benazolin(-ethyl); bencarbzone; benfluralin; benfuresate; benoxacor; bensulfuron(-methyl); bensulide; bentazone; benzfendizone; benzobicyclon, benzofenap; benzofluor; benzoylprop(-ethyl); benzthiazuron; bialaphos; bifenox; bispyribac(-sodium), borax; bromacil; bromobutide; bromofenoxim; bromoxynil (-octanoate); bromuron; buminafos; busoxinone; butachlor; butafenacil, butamifos; butenachlor; buthidazole; butralin; butroxydim, butylate; cafenstrole (CH-900); carbetamide; carfentrazone(-ethyl); caloxydim, CDAA, i.e. 2-chloro-N,N-di-2-propenylacetamide; CDEC, i.e. 2-chloroallyl diethyldithiocarbamate; chlomethoxyfen; chloramben; chlorazifop-butyl, chlorbromuron; chlorbufam; chlorfenac; chlorfenprop; chlorflurecol(-methyl); chlorflurenol(-methyl); chloridazon; chlorimuron(-ethyl); chlormequat(-chloride); chlormesulon (ICI-A0051); chlornitrofen; chlorotoluron; chloroxuron; chlorpropham; chlorsulfuron; chlorthal-dimethyl; chlorthiamid; chlortoluron, cinidon(-methyl and -ethyl), cinmethylin; cinosulfuron; clefoxydim, clethodim; clodinafop and its ester derivatives (e.g. clodinafop-propargyl); clofencet; clomazone; clomeprop; cloproxydim; clopyralid; clopyrasulfuron(-methyl), cloquintocet(-mexyl); cloransulam(-methyl), cumyluron (JC 940); cyanamide; cyanazine; cycloate; cyclosulfamuron (AC 104); cycloxydim; cycluron; cyhalofop and its ester derivatives (e.g. butyl ester, DEH-112); cyperquat; cyprazine; cyprazole; cyprosulfamide; daimuron; 2,4-D, 2,4-DB; dalapon; daminozide; dazomet; n-decanol; desmedipham; desmetryn; di-allate; dicamba; dichlobenil; dichlormid; dichlorprop(-P) salts; diclofop and its esters such as diclofop-methyl; diclofop-P(-methyl); diclosulam, diethatyl(-ethyl); difenoxuron; difenzoquat(-metilsulfate); diflufenican; diflufenzopyr, dimefuron; dimepiperate, dimethachlor; dimethametryn; dimethazone; dimethenamid (SAN-582H); dimethenamide-P; dimethylarsinic acid; dimexyflam, dimethipin; dimetrasulfuron, dinitramine; dinoseb; dinoterb; diphenamid; dipropetryn; diquat salts; dithiopyr; diuron; DNOC; eglinazine-ethyl; EL 77, i.e. 5-cyano-1-(1,1-dimethylethyl)-N-methyl-1H-pyrazole-4-carboxamide; endothal; epoprodan, EPTC; esprocarb; ethalfluralin; ethametsulfuron-methyl; ethidimuron; ethiozin; ethofumesate; ethoxyfen and its esters (e.g. ethyl ester, HN-252); ethoxysulfuron, etobenzanid (HW 52); F5231, i.e. N-[2-chloro-4-fluoro-5-[4-(3-fluoropropyl)-4,5-dihydro-5-oxo-1H-tetrazol-1-yl]-phenyl]ethanesulfonamide; fenchlorazole(-ethyl); fenclorim; fenoprop; fenoxan, fenoxaprop and fenoxaprop-P and their esters, e.g. fenoxaprop-P-ethyl and fenoxaprop-ethyl; fenoxydim; fentrazamide, fenuron; ferrous sulfate; flamprop(-methyl or -isopropyl or -isopropyl-L); flamprop-M(-methyl or -isopropyl); flazasulfuron; florasulam, fluazifop and fluazifop-P and their esters, e.g. fluazifop-butyl and fluazifop-P-butyl; fluazolate, flucarbazone(-sodium), flucetosulfuron; fluchloralin; flufenacet; flufenpyr(-ethyl); flumetralin; flumetsulam; flumeturon; flumiclorac(-pentyl), flumioxazin (S-482); flumipropyn; fluometuron, fluorochloridone, fluorodifen; fluoroglycofen(-ethyl); flupoxam (KNW-739); flupropacil (UBIC-4243); flupropanoate; flupyrsulfuron(-methyl)(-sodium); flurazole; flurenol(-butyl); fluridone; flurochloridone; fluroxypyr(-meptyl); flurprimidol, flurtamone; fluthiacet(-methyl), fluthiamide, fluxofenim; fomesafen; foramsulfuron, forchlorfenuron; fosamine; furilazole; furyloxyfen; gibberillic acid; glufosinate(-ammonium); glyphosate(-isopropyl-ammonium); halosafen; halosulfuron(-methyl); haloxyfop and its esters; haloxyfop-P (═R-haloxyfop) and its esters; HC-252; hexazinone; imazamethabenz(-methyl); imazamethapyr, imazamox, imazapic, imazapyr; imazaquin and salts such as the ammonium salt; imazethamethapyr; imazethapyr; imazosulfuron; inabenfide; indanofan; indole-3-acetic acid; 4-indol-3-ylbutyric acid; iodosulfuron-methyl(-sodium); ioxynil; isocarbamid; isopropalin; isoproturon; isouron; isoxaben; isoxachlortole, isoxadifen(-ethyl); isoxaflutole, isoxapyrifop; karbutilate; lactofen; lenacil; linuron; MCPA; MCPB; mecoprop(-P); mefenacet; mefenpyr(-diethyl); mefluidid; mepiquat(-chloride); mesosulfuron(-methyl); mesotrione, metam; metamifop; metamitron; metazachlor; methabenzthiazuron; metham; methazole; methoxyphenone; methylarsonic acid; methyl-cyclopropene; methyldymron; methylisothiocyanate; methabenzthiazuron; metobenzuron; metobromuron; (alpha-)metolachlor; metosulam (XRD511); metoxuron; metribuzin; metsulfuron-methyl; MH; MK-616; molinate; monalide; monocarbamide dihydrogensulfate; monolinuron; monuron; MT 128, i.e. 6-chloro-N-(3-chloro-2-propenyl)-5-methyl-N-phenyl-3-pyridazinamine; MT 5950, i.e. N-[3-chloro-4-(1-methylethyl)phenyl]-2-methylpentanamide; naproanilide; napropamide; naptalam; NC 310, i.e. 4-(2,4-dichlorbenzoyl)-1-methyl-5-benzyloxypyrazole; neburon; nicosulfuron; nipyraclofen; nitralin; nitrofen; nitrophenolate mixture; nitrofluorfen; nonanoic acid; norflurazon; orbencarb; orthasulfamuron; oxabetrinil; oryzalin; oxadiargyl (RP-020630); oxadiazon; oxasulfuron, oxaziclomefone, oxyfluorfen; paclobutrazol; paraquat(-dichloride); pebulate; pelargonic acid, pendimethalin; penoxulam; pentachlorophenol; pentanochlor; pentoxazone, perfluidone; pethoxamid; phenisopham; phenmedipham; picloram; picolinafen, pinoxaden, piperophos; piributicarb; pirifenop-butyl; pretilachlor; primisulfuron(-methyl); probenazole; procarbazone-(sodium), procyazine; prodiamine; profluralin; profoxydim; prohexadione(-calcium); prohydrojasmon; proglinazine(-ethyl); prometon; prometryn; propachlor; propanil; propaquizafop; propazine; propham; propisochlor; propoxycarbazone(-sodium); n-propyl-dihydrojasmonate; propyzamide; prosulfalin; prosulfocarb; prosulfuron (CGA-152005); prynachlor; pyraclonil; pyraflufen(-ethyl), pyrasulfotole; pyrazolynate; pyrazon; pyrazosulfuron(-ethyl); pyrazoxyfen; pyribenzoxim, pyributicarb, pyridafol, pyridate; pyriftalid; pyriminobac(-methyl), pyrimisulfan; pyrithiobac(-sodium) (KIH-2031); pyroxasulfone; pyroxofop and its esters (e.g. propargyl ester); pyroxulam; quinclorac; quinmerac; quinoclamine, quinofop and its ester derivatives, quizalofop and quizalofop-P and their ester derivatives, e.g. quizalofop-ethyl; quizalofop-P-tefuryl and -ethyl; renriduron; rimsulfuron (DPX-E 9636); S 275, i.e. 2-[4-chloro-2-fluoro-5-(2-propynyloxy)phenyl]-4,5,6,7-tetrahydro-2H-indazole; secbumeton; sethoxydim; siduron; simazine; simetryn; sintofen; SN 106279, i.e. 2-[[7-[2-chloro-4-(trifluoromethyl)phenoxy]-2-naphthalenyl]oxy]propanoic acid and its methyl ester; sulcotrione, sulfentrazone (FMC-97285, F-6285); sulfazuron; sulfometuron(-methyl); sulfosate (ICI-A0224); sulfosulfuron, TCA; tebutam (GCP-5544); tebuthiuron; tecnacene; tembotrione; tefuryltrione; tepraloxydim, terbacil; terbucarb; terbuchlor; terbumeton; terbuthylazine; terbutryn; TFH 450, i.e. N,N-diethyl-3-[(2-ethyl-6-methylphenyl)sulfonyl]-1H-1,2,4-triazole-1-carboxamide; thenylchlor (NSK-850); thiafluamide, thiazafluron; thiazopyr (Mon-13200); thidiazimin (SN-24085); thiencarbazone(-methyl); thifensulfuron(-methyl); thiobencarb; Ti 35; tiocarbazil; topramezone; tralkoxydim; tri-allate; triasulfuron; triaziflam, triazofenamide; tribenuron(-methyl); triclopyr; tridiphane; trietazine; trifloxysulfuron; trifluralin; triflusulfuron and esters (e.g. methyl ester, DPX-66037); trimeturon; trinexapac; tritosulfuron, tsitodef; uniconazole; vernolate; WL 110547, i.e. 5-phenoxy-1-[3-(trifluoromethyl)phenyl]-1H-tetrazole; BAY MKH 6561, UBH-509; D-489; LS 82-556; KPP-300; NC-324; NC-330; KH-218; DPX-N8189; SC-0774; DOWCO-535; DK-8910; V-53482; PP-600; MBH-001; KIH-9201; ET-751; KIH-6127, KIH-2023, KIH-5996 and KIH-485.

From among the herbicidally active compounds mentioned above, preference is given to compounds from the group of the “sulfonamides”, preferably phenylsulfonamides, such as phenylsulfonylaminocarbonyltriazolinones or phenylsulfonylureas, heteroarylsulfonamides and other sulfonamides, such as cyclosulfamuron, or (alkylsulfonyl)alkylaminosulfonamides, such as amidosulfuron, and also salts thereof. Preferred phenylsulfonamides are compounds from the group of the phenylsulfonylaminocarbonyltriazolinones or the phenylsulfonylureas. The term phenylsulfonylureas is to be understood as including those sulfonylureas in which the phenyl group is attached via a spacer such as CH₂, O or NH to the sulfone group (SO₂). Examples of phenylsulfonylaminocarbonyltriazolinones are flucarbazone, propoxycarbazone or methyl 4-[(4,5-dihydro-3-methoxy-4-methyl-5-oxo-1H-1,2,4-triazol-1-yl)carboxamidosulfonyl]-5-methylthiophene-3-carboxylate (e.g. known, for example, from WO-A-03/026427, Example 1-2), and/or their salts. The sulfonamides are commercially available and/or can be prepared by known processes as described, for example, in EP-A-7687, EP-A-30138, U.S. Pat. No. 5,057,144 and U.S. Pat. No. 5,534,486.

Suitable phenylsulfonamides are for example phenylsulfonamides of the formula (I) and/or salts thereof,

R^{α}-(A)ₘ-SO₂—NR^{β}—CO—(NR⁷)ₙ—R^{δ} (I)

in which
R^{α} is an unsubstituted or substituted phenyl radical, where the phenyl radical including substituents has 6-30 carbon atoms, preferably 6-20 carbon atoms,
R^{β} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
R^{γ} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
A is CH₂, O or NH, preferably O,
m is zero or 1,
n is zero or 1, preferably 1, and
R^{δ} is a heterocyclic radical, such as a pyridyl radical, a triazinyl radical or a triazolinone radical.

Preferred phenylsulfonamides are phenylsulfonylureas, for example phenylsulfonylureas of the formula (II) and/or salts thereof,

R^{α}-(A)ₘ-SO₂—NR^{β}—CO—NR^{γ}—R^{δ} (II)

in which
R^{α} is an unsubstituted or substituted phenyl radical, where the phenyl radical including substituents has 6-30 carbon atoms, preferably 6-20 carbon atoms,
R^{β} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
R^{γ} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
A is CH₂, O or NH, preferably O,
m is zero or 1, and
R^{δ} is a heterocyclic radical, such as a pyrimidinyl radical or a triazinyl radical.

Preference is given to phenylsulfonylureas of the formula (III) and/or salts thereof,

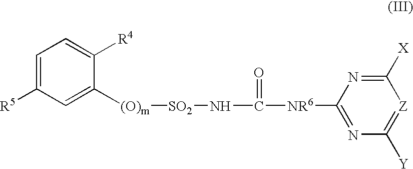

in which
R⁴ is C₁-C₄-alkoxy, preferably C₂-C₄-alkoxy, or CO—R^{a}, where R^{a} is OH, C₁-C₄-alkoxy or NR^{b}R^{c}, where R^{b} and R^{c} are identical or different and independently of one another are H or C₁-C₄-alkyl,
R⁵ is halogen, preferably iodine, or (A)ₙ-NR^{d}R^{e} where n is zero or 1, A is a group CR′R″ in which R′ and R″ independently of one another are identical or different radicals from the group consisting of H and C₁-C₄-alkyl, R^{d} is H or C₁-C₄-alkyl and R^{e} is an acyl radical, such as formyl, or C₁-C₄-alkylsulfonyl, and in the case that R⁴ is C₁-C₄-alkoxy, preferably C₂-C₄-alkoxy, R⁵ may also be H,
R⁶ is H or C₁-C₄-alkyl,
m is zero or 1,
X and Y are identical or different and independently of one another are halogen or NR′R″, where R′ and R″ are identical or different and are H or C₁-C₄-alkyl, or C₁-C₆-alkyl, C₁-C₆-alkoxy, C₁-C₆-alkylthio, C₃-C₆-cycloalkyl, C₂-C₆-alkenyl, C₂-C₆-alkynyl, C₃-C₆-alkenyloxy or C₃-C₆-alkynyloxy, where each of the eight last-mentioned radicals is unsubstituted or substituted by one or more radicals from the group consisting of halogen, C₁-C₄-alkoxy and C₁-C₄-alkylthio, preferably C₁-C₄-alkyl or C₁-C₄-alkoxy, and
Z is CH or N.

Particular preference is given to phenylsulfonylureas of the formula (III) and/or salts thereof, in which
a) R⁴ is CO—(C₁-C₄-alkoxy), R⁵ is halogen, preferably iodine, or R⁵ is CH₂—NHR^{e}, where R^{e} is an acyl radical, preferably C₁-C₄-alkylsulfonyl, and m is zero,
b) R⁴ is CO—N(C₁-C₄-alkyl)₂, R⁵ is NHR^{e}, where R^{e} is an acyl radical, preferably formyl, and m is zero, or
c) R⁴ is C₂-C₄-alkoxy, R⁵ is H and m is 1.

Typical phenylsulfonylureas are, inter alia, the compounds listed below and their salts, such as the sodium salts: bensulfuron-methyl, chlorimuron-ethyl, chlorsulfuron, cinosulfuron, cyclosulfamuron, ethametsulfuron-methyl, ethoxysulfuron and its sodium salt, metsulfuron-methyl, oxasulfuron, primisulfuron-methyl, prosulfuron, sulfometuron-methyl, triasulfuron, tribenuron-methyl, triflusulfuron-methyl, tritosulfuron, iodosulfuron-methyl and its sodium salt (WO-A-92/13845), mesosulfuron-methyl and its sodium salt (Agrow No. 347, Mar. 3, 2000, page 22 (PJB Publications Ltd. 2000)) and foramsulfuron and its sodium salt (Agrow No. 338, Oct. 15, 1999, page 26 (PJB Publications Ltd. 1999)).

Particularly preferred phenylsulfonamides are: iodosulfuron-methyl and its sodium salt, mesosulfuron-methyl and its sodium salt, foramsulfuron and its sodium salt, flucarbazone and its sodium salt, propoxycarbazone and its sodium salt, methyl 4-[(4,5-dihydro-3-methoxy-4-methyl-5-oxo-1H-1,2,4-triazol-1-yl)carboxamidosulfonyl]-5-methylthiophene-3-carboxylate and its sodium salt, and ethoxysulfuron and its sodium salt, metsulfuron-methyl and its sodium salt, tribenuron-methyl and its sodium salt, chlorsulfuron and its sodium salt.

Suitable heteroarylsulfonamides are, for example, compounds from the group of the heteroarylsufonylaminocarbonyltriazolinones or heteroarylsulfonylureas, preferably from the group of the heteroarylsulfonylureas. The term “heteroarylsulfonylureas” is to be understood as including those sulfonylureas in which the heteroaryl group is attached via a spacer such as CH₂, O or NH to the sulfone group (SO₂).

Suitable heteroarylsulfonamides are, for example, sulfonamides of the formula (IV) and/or salts thereof,

R^{α′}-(A′)ₘ-SO₂—NR^{β′}—CO—(NR^{γ}′)_{n′}—R^{δ′} (IV)

in which
R^{α}′ is an unsubstituted or substituted heteroaryl radical, where the heteroaryl radical including substituents has 1-30 carbon atoms, preferably 1-20 carbon atoms,
R^{β}′ is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
R^{γ}′ is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
A′ is CH₂, O or NH, preferably O,
m′ is zero or 1,
n′ is zero or 1, preferably 1, and
R^{δ}′ is a heterocyclic radical, such as a pyrimidinyl radical, a triazinyl radical or a triazolinone radical.

Preferred heteroarylsulfonamides are heteroarylsulfonylureas, for example sulfonylureas of the formula (V) and/or salts thereof,

R^{α′}-(A′)_{m′}-SO₂—NR^{β′}—CO—NR^{γ′}—R^{δ′} (V)

in which
R^{α}′ is an unsubstituted or substituted heteroaryl radical, where the heteroaryl radical including substituents has 1-30 carbon atoms, preferably 1-20 carbon atoms,
R^{β}′ is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
R^{γ}′ is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
A′ is CH₂, O or NH, preferably O,
m′ is zero or 1, and
R^{δ}′ is a heterocyclic radical, such as a pyrimidinyl radical or a triazinyl radical.

Particular preference is given to heteroarylsulfonamides of the formula (VI) below,

R^{α′}—SO₂—NH—CO—(NR^{γ}′)_{n′}—R^{δ′} (VI)

in which
R^{α}′ is a substituted heteroaryl radical such as substituted pyridyl, thienyl, pyrazolyl or imidazolyl,
R^{γ}′ is H, (C₁-C₃)-alkyl, unsubstituted or substituted by halogen (F, C, Br, I) or halo-(C₁-C₃)-alkoxy, preferably H or methyl,
when n′ is 1, R^{δ}′ is a pyrimidinyl radical or a triazinyl radical, preferably

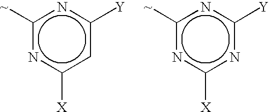

and when n′ is zero, R^{δ}′ is a triazolinone radical, preferably

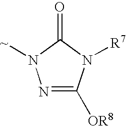

R⁷ is (C₁-C₁₀)-alkyl which is optionally substituted by halogen (F, Cl, Br, I) or (C₁-C₃)-haloalkyl,
R⁸ is (C₁-C₁₀)alkyl which is optionally substituted by halogen (F, Cl, Br, I) or (C₁-C₃)-haloalkyl,
X and Y are identical or different and independently of one another are halogen or NR′R″, where R′ and R″ are identical or different and are H or C₁-C₄-alkyl, or C₁-C₆-alkyl, C₁-C₆-alkoxy, C₁-C₆-alkylthio, C₃-C₆-cycloalkyl, C₂-C₆-alkenyl, C₂-C₆-alkynyl, C₃-C₆-alkenyloxy or C₃-C₆-alkynyloxy, where each of the eight last-mentioned radicals is unsubstituted or substituted by one or more radicals from the group consisting of halogen, C₁-C₄-alkoxy and C₁-C₄-alkylthio, preferably C₁-C₄-alkyl or C₁-C₄-alkoxy.

Particularly preferably, R^{α}′ is

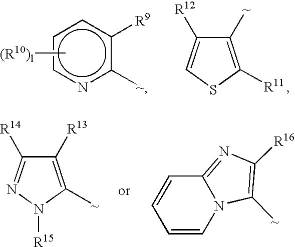

in which
R⁹ is (C₁-C₆)-alkyl, (C₁-C₆)-alkoxy, (C₂-C₆)-alkenyloxy, (C₂-C₆)-alkynyloxy, (C₁-C₆)-alkylsulfonyl, (C₁-C₆)-alkylcarbonyl, (C₁-C₆)-alkoxycarbonyl, (C₂-C₆)-alkenyloxycarbonyl, (C₂-C₆)-alkynyloxycarbonyl, CONR′R″, halo-(C₁-C₆)-alkyl, halo-(C₁-C₆)-alkoxy, halo-(C₂-C₆)-alkenyloxy, halo-(C₂-C₆)-alkynyloxy, halo-(C₁-C₆)-alkylsulfonyl, halo-(C₁-C₆)-alkylcarbonyl, halo-(C₁-C₆)-alkoxycarbonyl, halo-(C₂-C₆)-alkenyloxycarbonyl, halo-(C₂-C₆)-alkynyloxycarbonyl,
R¹⁰ is H, (C₁-C₃)-alkyl, (C₁-C₃)-alkoxy, halo-(C₁-C₃)-alkyl, halo-(C₁-C₃)-alkoxy or halogen (F, Cl, Br, I),
I is zero or 1,
R¹¹ is (C₁-C₆)-alkyl, (C₁-C₆)-alkoxy, (C₂-C₆)-alkenyloxy, (C₂-C₆)-alkynyloxy, (C₁-C₆)-alkylsulfonyl, (C₁-C₆)-alkylcarbonyl, (C₁-C₆)-alkoxycarbonyl, (C₂-C₆)-alkenyloxycarbonyl, (C₂-C₆)-alkynyloxycarbonyl, halo-(C₁-C₆)-alkyl, halo-(C₁-C₆)-alkoxy, halo-(C₂-C₆)-alkenyloxy, halo-(C₂-C₆)-alkynyloxy, halo-(C₁-C₆)-alkylsulfonyl, halo-(C₁-C₆)-alkylcarbonyl, halo-(C₁-C₆)-alkoxycarbonyl, halo-(C₂-C₆)-alkenyloxycarbonyl, halo-(C₂-C₆)-alkynyloxycarbonyl, CONR′R″,
R¹² is halogen (F, Cl, Br, I), (C₁-C₆)-alkyl, (C₁-C₆)-alkoxy, (C₁-C₆)-alkylsulfonyl, (C₁-C₆)-alkoxycarbonyl, (C₂-C₆)-alkenyloxycarbonyl, (C₂-C₆)-alkynyloxycarbonyl, halo-(C₁-C₆)-alkyl, halo-(C₁-C₆)-alkoxy, halo-(C₁-C₆)-alkylsulfonyl, halo-(C₁-C₆)-alkoxycarbonyl, halo-(C₂-C₆)-alkenyloxycarbonyl, halo-(C₂-C₆)-alkynyloxycarbonyl,
R¹³ is (C₁-C₆)-alkoxycarbonyl, (C₂-C₆)-alkenyloxycarbonyl, (C₂-C₆)-alkynyloxycarbonyl, (C₁-C₆)-alkyl, (C₁-C₆)-alkoxy, (C₁-C₆)-alkylsulfonyl, halo-(C₁-C₆)-alkoxycarbonyl, halo-(C₂-C₆)-alkenyloxycarbonyl, halo-(C₂-C₆)-alkynyloxycarbonyl, halo-(C₁-C₆)-alkyl, halo-(C₁-C₆)-alkoxy, halo-(C₁-C₆)-alkylsulfonyl, halogen (F, Cl, Br, I), CONR′R″, or R¹³ is a heterocyclic ring, which may be saturated, unsaturated or aromatic and which preferably contains 4-6 ring atoms and one or more heteroatoms from the group consisting of N, O and S and which may be unsubstituted or substituted by one or more substituents, preferably from the group consisting of (C₁-C₃)-alkyl, (C₁-C₃)-alkoxy, halo-(C₁-C₃)-alkyl, halo-(C₁-C₃)-alkoxy and halogen, particularly preferably

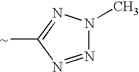

R¹⁴ is H, halogen (F, C, Br, I), (C₁-C₆)-alkyl, halo-(C₁-C₆)-alkyl,
R¹⁵ is H, (C₁-C₆)-alkyl, halo-(C₁-C₆)-alkyl,
R¹⁶ is (C₁-C₆)-alkyl, (C₁-C₆)-alkoxy, (C₂-C₆)-alkenyloxy, (C₂-C₆)-alkynyloxy, (C₁-C₆)-alkylsulfonyl, (C₁-C₆)-alkylcarbonyl, (C₁-C₆)-alkoxycarbonyl, (C₂-C₆)-alkenyloxycarbonyl, (C₂-C₆)-alkynyloxycarbonyl, halo-(C₁-C₆)-alkyl, halo-(C₁-C₆)-alkoxy, halo-(C₂-C₆)-alkenyloxy, halo-(C₂-C₆)-alkynyloxy, halo-(C₁-C₆)-alkylsulfonyl, halo-(C₁-C₆)-alkylcarbonyl, halo-(C₁-C₆)-alkoxycarbonyl, halo-(C₂-C₆)-alkenyloxycarbonyl, halo-(C₂-C₆)-alkynyloxycarbonyl, CONR′R″, in particular SO₂-ethyl, and
R′ and R″ independently of one another are H, (C₁-C₆)-alkyl, halo-(C₁-C₆)-alkyl, (C₂-C₆)-alkenyl, (C₂-C₆)-haloalkenyl, (C₂-C₆)-alkynyl, (C₂-C₆)-haloalkynyl, or NR′R″ forms a heterocyclic ring which may be saturated, unsaturated or aromatic and which preferably contains 4-6 ring atoms and one or more heteroatoms from the group consisting of N, O and S and which may be unsubstituted or substituted by one or more substituents, preferably from the group consisting of (C₁-C₃)-alkyl, (C₁-C₃)-alkoxy, halo-(C₁-C₃)-alkyl, halo-(C₁-C₃)-alkoxy and halogen.

Particularly preferred heteroarylsulfonylureas are, for example, nicosulfuron and its salts, such as the sodium salt, rimsulfuron and its salts, such as the sodium salt, thifensulfuron-methyl and its salts, such as the sodium salt, pyrazosulfuron-ethyl and its salts, such as the sodium salt, flupyrsulfuron-methyl and its salts, such as the sodium salt, sulfosulfuron and its salts, such as the sodium salt, trifloxysulfuron and its salts, such as the sodium salt, azimsulfuron and its salts, such as the sodium salt, flazasulfuron and its salts, such as the sodium salt, and flucetosulfuron (1-[3-[[[[(4,6-dimethoxy-2-pyrimidinyl)amino]carbonyl]amino]sulfonyl]-2-pyridinyl]-2-fluoropropyl methoxyacetate) and its salts, such as the sodium salt.

For the purpose of the present invention, the sulfonamides (component b) contained in the formulations according to the invention are in each case to be understood as meaning all use forms, such as acids, esters, salts and isomers, such as stereoisomers and optical isomers. Thus, in addition to neutral compounds, their salts with inorganic and/or organic counterions are in each case meant to be included. Thus, sulfonamides are capable of forming salts, for example, in which the hydrogen of the —SO₂—NH group is replaced by an agriculturally suitable cation. These salts are, for example, metal salts, in particular alkali metal salts or alkaline earth metal salts, in particular sodium and potassium salts, or else ammonium salts or salts with organic amines. Salt formation may also take place by addition of an acid to basic groups, such as, for example, amino and alkylamino. Acids suitable for this purpose are strong inorganic and organic acids, for example HCl, HBr, H₂SO₄ or HNO₃. Preferred esters are the alkyl esters, in particular the C₁-C₁₀-alkyl esters, such as methyl esters.

Whenever the term “acyl radical” is used in the abovementioned description, this means the radical of an organic acid which is formally formed by removing an OH group from the organic acid, for example the radical of a carboxylic acid and radicals of acids derived therefrom, such as thiocarboxylic acid, unsubstituted or N-substituted iminocarboxylic acids or the radicals of carbonic monoesters, unsubstituted or N-substituted carbaminic acids, sulfonic acids, sulfinic acids, phosphonic acids, phosphinic acids. An acyl radical is preferably formyl or acyl from the group consisting of CO—R^{z}, CS—R^{z}, CO—OR^{z}, CS—OR^{z}, CS—SR^{z}, SOR^{z} and SO₂R^{z}, where R^{z} is in each case a C₁-C₁₀-hydrocarbon radical, such as C₁-C₁₀-alkyl or C₆-C₁₀-aryl, which is unsubstituted or substituted, for example by one or more substituents from the group consisting of halogen, such as F, Cl, Br, I, alkoxy, haloalkoxy, hydroxyl, amino, nitro, cyano and alkylthio, or R^{z} is aminocarbonyl or aminosulfonyl, where the two last-mentioned radicals are unsubstituted, N-monosubstituted or N,N-disubstituted, for example by substituents from the group consisting of alkyl and aryl. Acyl is, for example, formyl, haloalkylcarbonyl, alkylcarbonyl, such as (C₁-C₄)-alkylcarbonyl, phenylcarbonyl, where the phenyl ring may be substituted, or alkyloxycarbonyl, such as (C₁-C₄)-alkyloxycarbonyl, phenyloxycarbonyl, benzyloxycarbonyl, alkylsulfonyl, such as (C₁-C₄)-alkylsulfonyl, alkylsulfinyl, such as C₁-C₄-(alkylsulfinyl), N-alkyl-1-iminoalkyl, such as N—(C₁-C₄)-1-imino-(C₁-C₄)-alkyl, and other radicals of organic acids. A hydrocarbon radical is a straight-chain, branched or cyclic and saturated or unsaturated aliphatic or aromatic hydrocarbon radical, for example alkyl, alkenyl, alkynyl, cycloalkyl, cycloalkenyl or aryl. A hydrocarbon radical has preferably 1 to 40 carbon atoms, with preference 1 to 30 carbon atoms; with particular preference, a hydrocarbon radical is alkyl, alkenyl or alkynyl having up to 12 carbon atoms or cycloalkyl having 3, 4, 5, 6 or 7 ring atoms or phenyl. Aryl is a mono-, bi- or polycyclic aromatic system, for example phenyl, naphthyl, tetrahydronaphthyl, indenyl, indanyl, pentalenyl, fluorenyl and the like, preferably phenyl. A heterocyclic radical or ring (heterocyclyl) can be saturated, unsaturated or heteroaromatic and unsubstituted or substituted; it preferably contains one or more heteroatoms in the ring, preferably from the group consisting of N, O and S; it is preferably an aliphatic heterocyclyl radical having 3 to 7 ring atoms or a heteroaromatic radical having 5 or 6 ring atoms and contains 1, 2 or 3 heteroatoms. The heterocyclic radical can, for example, be a heteroaromatic radical or ring (heteroaryl), such as, for example, a mono-, bi- or polycyclic aromatic system in which at least one ring contains one or more heteroatoms, for example pyridyl, pyrimidinyl, pyridazinyl, pyrazinyl, triazinyl, thienyl, thiazolyl, oxazolyl, furyl, pyrrolyl, pyrazolyl and imidazolyl, or it is a partially or fully hydrogenated radical, such as oxiranyl, oxetanyl, pyrrolidyl, piperidyl, piperazinyl, triazolyl, dioxolanyl, morpholinyl, tetrahydrofuryl. Preference is given to pyrimidinyl and triazinyl. Suitable substituents for a substituted heterocyclic radical are the substituents mentioned further below, and additionally also oxo. The oxo group may also be present at the hetero ring atoms, which may exist in different oxidation states, for example in the case of N and S. Substituted radicals, such as substituted hydrocarbon radicals, for example substituted alkyl, alkenyl, alkynyl, aryl, phenyl and benzyl, or substituted heterocyclyl or heteroaryl, are, for example, a substituted radical which is derived from an unsubstituted parent compound, where the substituents are, for example, one or more, preferably 1, 2 or 3, radicals from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkyl-sulfinyl, alkylsulfonyl, haloalkylsulfonyl and, in the case of cyclic radicals, also alkyl and haloalkyl, and unsaturated aliphatic radicals which correspond to the saturated hydrocarbon-containing radicals mentioned, such as alkenyl, alkynyl, alkenyloxy, alkynyloxy, etc. Among the radicals with carbon atoms, preference is given to those having 1 to 4 carbon atoms, in particular 1 or 2 carbon atoms. Preference is generally given to substituents from the group consisting of halogen, for example fluorine and chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro and cyano. Particular preference is given here to the substituents methyl, methoxy and chlorine. Unsubstituted or substituted phenyl is preferably phenyl which is unsubstituted or mono- or polysubstituted, preferably substituted up to three times, by identical or different radicals, preferably from the group consisting of halogen, (C₁-C₄)-alkyl, (C₁-C₄)-alkoxy, (C₁-C₄)-haloalkyl, (C₁-C₄)-haloalkoxy and nitro, for example o-, m- and p-tolyl, dimethylphenyl, 2-, 3- and 4-chlorophenyl, 2-, 3- and 4-trifluoro- and -trichlorophenyl, 2,4-, 3,5-, 2,5- and 2,3-dichlorophenyl, o-, m- and p-methoxyphenyl. Cycloalkyl is a carbocyclic saturated ring system having preferably 3-6 carbon atoms, for example cyclopropyl, cyclobutyl, cyclopentyl or cyclohexyl. The carbon skeleton of the carbon-containing radicals, such as alkyl, alkoxy, haloalkyl, haloalkoxy, alkylamino and alkylthio and the corresponding unsaturated and/or substituted radicals, can in each case be straight-chain or branched. In these radicals, preference is given to the lower carbon skeletons having, for example, 1 to 6 carbon atoms and, in the case of unsaturated groups, 2 to 6 carbon atoms, unless specified otherwise. Alkyl radicals, also in the composite meanings such as alkoxy, haloalkyl, etc., are, for example, methyl, ethyl, n- or isopropyl, n-, iso-, t- or 2-butyl, pentyls, hexyls, such as n-hexyl, isohexyl and 1,3-dimethylbutyl, heptyls, such as n-heptyl, 1-methylhexyl and 1,4-dimethylpentyl; alkenyl and alkynyl radicals have the meaning of the possible unsaturated radicals which correspond to the alkyl radicals; alkenyl is, for example, allyl, 1-methylprop-2-en-1-yl, 2-methylprop-2-en-1-yl, but-2-en-1-yl, but-3-en-1-yl, 1-methylbut-3-en-1-yl and 1-methylbut-2-en-1-yl; alkynyl is, for example, propargyl, but-2-yn-1-yl, but-3-yn-1-yl, 1-methylbut-3-yn-1-yl. Halogen is, for example, fluorine, chlorine, bromine or iodine. Haloalkyl, -alkenyl and -alkynyl is alkyl, alkenyl and alkynyl, respectively, which is partially or fully substituted by halogen, preferably by fluorine, chlorine and/or bromine, in particular by fluorine or chlorine, for example CF₃, CHF₂, CH₂F, CF₃CF₂, CH₂FCHCl, CCl₃, CHCl₂, CH₂CH₂Cl; haloalkoxy is, for example, OCF₃, OCHF₂, OCH₂F, CF₃CF₂O, OCH₂CF₃ and OCH₂CH₂Cl; this applies correspondingly to haloalkenyl and other halogen-substituted radicals.

From among the active compounds from the group of the sulfonamides and their salts (component a) very particular preference is given to propoxycarbazone and its sodium salt (propoxycarbazone-methyl-sodium), methyl 4-[(4,5-dihydro-3-methoxy-4-methyl-5-oxo-1H-1,2,4-triazol-1-yl)carboxamidosulfonyl]-5-methylthiophene-3-carboxylate and its sodium salt, amidosulfuron and its sodium salt (amidosulfuron-methyl-sodium), iodosulfuron-methyl and its sodium salt (iodosulfuron-methyl-sodium), foramsulfuron and its sodium salt, thifensulfuron-methyl and its sodium salt and mesosulfuron-methyl and its sodium salt.

In general, the formulations according to the invention comprise the active compounds from the group of the sulfonamides and their salts (component b) in amounts of 0.1-80% by weight, preferably 1-75% by weight, particularly preferably 3-50% by weight, very particularly preferably 5-25% by weight.

The agrochemically active compounds may also be growth regulators. Examples of these are cyclanilide, ethephon, tribufos and thidiazuron.

In the sense of the present invention, the active compounds comprised as component b) in the formulations according to the invention are in each case to be understood as including, in addition to the neutral compounds, also their salts with inorganic and/or organic counterions. Thus, sulfonylureas are capable of forming salts, for example, in which the hydrogen of the —SO₂—NH group is replaced by an agriculturally suitable cation. These salts are, for example, metal salts, in particular alkali metal salts or alkaline earth metal salts, in particular sodium salts and potassium salts, or else ammonium salts or salts with organic amines. Salt formation may also take place by addition of an acid to basic groups, such as, for example, amino and alkylamino. Acids suitable for this purpose are strong inorganic and organic acids, for example HCl, HBr, H₂SO₄ or HNO₃. An example is iodosulfuron-methyl-sodium.

The herbicides listed above (compounds from the group of the sulfonamides, plant growth regulators) are known, for example, from “The Pesticide Manual”, 12th edition (2000), 13th edition (2003) and 14th edition (2006), The British Crop Protection Council, or from the literature references given after the individual active compounds.

Preference is given to herbicides, such as representatives from the group of the “sulfonamides” defined above, preferably, for example, herbicides with foliar activity, such as ALS inhibitors (for example sulfonamides, such as thiencarbazone(-methyl), flucarbazone, propoxycarbazone or amicarbazone, or sulfonylureas, such as mesosulfuron, iodosulfuron-methyl(-sodium), ethoxysulfuron, amidosulfuron, foramsulfuron), diflufenican, herbicides from the class of the benzoylcyclohexane-diones, such as tembotrione, bromoxynil-containing or ioxynil-containing products, herbicides from the class of the aryloxyphenoxypropionates, such as fenoxaprop-P-ethyl, herbicides from the class of the oxyacetamides (for example flufenacet and mefenacet), herbicides from the class of the triazolopyrimidinesulfonamide derivatives (for example flumetsulam, metosulam), sugar beet herbicides, such as desmedipham, phenmedipham, ethofumesate or metamitron, active compounds from the class of the HPPD inhibitors (for example isoxaflutole, sulcotrione, mesotrione) or else active compounds from the group of the phosphorus-containing herbicides or their derivatives, such as salts, such as, for example, glufosinate and its ammonium salt in racemic form, i.e. 2-amino-4-[hydroxy(methyl)phosphinoyl]-butanoic acid or its ammonium salt, the L-enantiomer of glufosinate and its ammonium salt, bilanafos/bialaphos, i.e. L-2-amino-4-[hydroxy(methyl)phosphinoyl]-butanoyl-L-alaninyl-L-alanine and its sodium salt, and also glyphosate.

Safeners

The agrochemically active compounds may also be safeners. Examples of these are
a) compounds of the dichlorophenylpyrazoline-3-carboxylic acid type, preferably compounds such as ethyl 1-(2,4-dichlorophenyl)-5-(ethoxycarbonyl)-5-methyl-2-pyrazoline-3-carboxylate (S1-1) (“mefenpyr-diethyl”, PM), and related compounds, as described in WO 91/07874:
b) derivatives of dichlorophenylpyrazole carboxylic acid, preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)5-(1,1-dimethylethyl)pyrazole-3-carboxylate (S1-4), ethyl 1-(2,4-dichlorophenyl)-5-phenylpyrazole-3-carboxylate (S1-5) and related compounds, as described in EP-A-333 131 and EP-A-269 806;
c) compounds of the triazolecarboxylic acid type, preferably compounds such as fenchlorazole(ethyl ester), i.e. ethyl 1-(2,4-dichlorophenyl)-5-trichloromethyl-(1H)-1,2,4-triazole-3-carboxylate (S1-6) and related compounds (EP-A-174 562 and EP-A-346 620);
d) compounds of the 5-benzyl- or 5-phenyl-2-isoxazoline-3-carboxylic acid type, or the 5,5-diphenyl-2-isoxazoline-3-carboxylic acid type, preferably compounds such as ethyl 5-(2,4-dichlorobenzyl)-2-isoxazoline-3-carboxylate (S1-7) or ethyl 5-phenyl-2-isoxazoline-3-carboxylate (S1-8) and related compounds, as described in WO 91/08202, or ethyl 5,5-diphenyl-2-isoxazolinecarboxylate (S1-9) (“isoxadifen-ethyl”) or the-n-propyl ester (S1-10) or ethyl 5-(4-fluorophenyl)-5-phenyl-2-isoxazoline-3-carboxylate (S1-11), as described in patent application WO-A-95/07897;
e) compounds of the 8-quinolineoxyacetic acid type (S2), preferably 1-methylhex-1-yl (5-chloro-8-quinolineoxy)acetate (common name “cloquintocet-mexyl” (S2-1) (see PM) 1,3-dimethylbut-1-yl (5-chloro-8-quinolineoxy)acetate (S2-2), 4-allyloxybutyl (5-chloro-8-quinolineoxy)acetate (S2-3), 1-allyloxyprop-2-yl (5-chloro-8-quinolineoxy)acetate (S2-4), ethyl (5-chloro-8-quinolineoxy)acetate (S2-5), methyl (5-chloro-8-quinolineoxy)acetate (S2-6), allyl (5-chloro-8-quinolineoxy)acetate (S2-7), 2-(2-propylideneiminoxy)-1-ethyl (5-chloro-8-quinolineoxy)acetate (S2-8) 2-oxoprop-1-yl (5-chloro-8-quinolineoxy)acetate (S2-9)
   and related compounds, as described in EP-A-86 750, EP-A-94 349 and EP-A-191 736 or EP-A-0 492 366;
f) compounds of the (5-chloro-8-quinolineoxy)malonic acid type, preferably compounds such as diethyl (5-chloro-8-quinolineoxy)malonate, diallyl (5-chloro-8-quinolineoxy)malonate, methyl ethyl (5-chloro-8-quinolineoxy)malonate and related compounds, as described in EP-A-0 582 198;
g) active compounds of the phenoxyacetic or -propionic acid derivative type or the aromatic carboxylic acid type, for example 2,4-dichlorophenoxyacetic acid/esters (2,4-D), 4-chloro-2-methylphenoxypropionic esters (mecoprop), MCPA or 3,6-dichloro-2-methoxybenzoic acid/esters (dicamba);
h) active compounds of the pyrimidine type, which are used as soil-acting safeners in rice, for example
   “fenclorim” (PM) (=4,6-dichloro-2-phenylpyrimidine), which is known as safener for pretilachlor in sown rice;
i) active compounds of the dichloroacetamide type, which are frequently used as pre-emergent safeners (soil-acting safeners), for example
   “dichlormid” (PM) (=N,N-diallyl-2,2-dichloroacetamide),
   “R-29148” (=3-dichloroacetyl-2,2,5-trimethyl-1,3-oxazolidine from Stauffer),
   “benoxacor” (PM) (=4-dichloroacetyl-3,4-dihydro-3-methyl-2H-1,4-benzoxazine).
   “PPG-1292” (=N-allyl-N-[(1,3-dioxolan-2-yl)methyl]dichloroacetamide from PPG Industries),
   “DK-24” (=N-allyl-N-[(allylaminocarbonyl)methyl]dichloroacetamide from Sagro-Chem),
   “AD-67” or “MON 4660” (=3-dichloroacetyl-1-oxa-3-aza-spiro[4,5]decane from Nitrokemia or Monsanto),
   “diclonon” or “BAS145138” or “LAB145138” (=3-dichloroacetyl-2,5,5-trimethyl-1,3-diazabicyclo[4.3.0]nonane from BASF) and
   “furilazol” or “MON 13900” (see PM) (═(RS)-3-dichloroacetyl-5-(2-furyl)-2,2-dimethyloxazolidine);
j) active compounds of the dichloroacetone derivative type, for example
   “MG 191” (CAS-Reg. No. 96420-72-3) (=2-dichloromethyl-2-methyl-1,3-dioxolane from Nitrokemia), which is known as safener for maize;
k) active compounds of the oxyimino compound type, which are known as seed dressings, for example
   “oxabetrinil” (PM) (=(Z)-1,3-dioxolan-2-ylmethoxyimino(phenyl)acetonitrile), which is known as a seed dressing safener for millet against metolachlor damage;
   “fluxofenim” (PM) (=1-(4-chlorophenyl)-2,2,2-trifluoro-1-ethanone O-(1,3-dioxolan-2-ylmethyl)oxime), which is known as a seed dressing safener for millet against metolachlor damage, and
   “cyometrinil” or “CGA-43089” (PM) (=(Z)-cyanomethoxy-imino(phenyl)acetonitrile), which is known as a seed dressing safener for millet against metolachlor damage;
l) active compounds of the thiazolecarboxylic ester type, which are known as seed dressings, for example
   “flurazol” (PM) (=benzyl 2-chloro-4-trifluoromethyl-1,3-thiazole-5-carboxylate), which is known as a seed dressing safener for millet against alachlor and metolachlor damage;
m) active compounds of the naphthalenedicarboxylic acid derivative type, which are known as seed dressings, for example
   “naphthalic anhydride” (PM) (=1,8-naphthalenedicarboxylic anhydride), which is known as a seed dressing safener for maize against thiocarbamate herbicide damage,
n) active compounds of the chromanacetic acid derivative type, for example
   “CL 304415” (CAS-Reg. No. 31541-57-8) (=2-(4-carboxychroman-4-yl)acetic acid from American Cyanamid), which is known as safener for maize against imidazolinone damage;
o) active compounds which, in addition to a herbidical action against harmful plants, also have safener action in crop plants such as rice, for example
   “dimepiperate” or “MY-93” (PM) (=S-1-methyl-1-phenylethyl piperidine-1-thiocarboxylate), which is known as safener for rice against herbicide molinate damage;
   “daimuron” or “SK 23” (PM) (=1-(1-methyl-1-phenylethyl)-3-p-tolylurea), which is known as safener for rice against herbicide imazosulfuron damage,
   “cumyluron”=“JC-940” (=3-(2-chlorophenylmethyl)-1-(1-methyl-1-phenylethyl)urea, see JP-A-60087254), which is known as safener for rice against damage by some herbicides,
   “methoxyphenon” or “NK 049” (=3,3′-dimethyl-4-methoxybenzophenone), which is known as safener for rice against damage by some herbicides,
   “CSB” (=1-bromo-4-(chloromethylsulfonyl)benzene) (CAS-Reg. No. 54091-06-4 from Kumiai), which is known as safener against damage by some herbicides in rice,
p) N-acylsulfonamides of the formula (S3) and salts thereof,

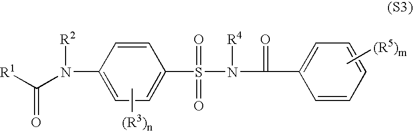

as described in WO-A-97/45016,
q) compounds of the type of the acylsulfamoylbenzamides of the formula (S4) below which are known, for example, from WO-A-99/16744,

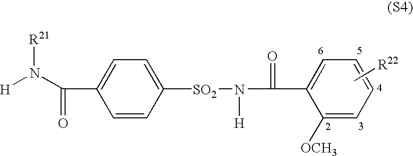

in which
R21=cyclopropyl and R22=H (4-cyclopropylaminocarbonyl-N-(2-methoxy-benzoyl)benzenesulfonamide; “cyprosulfamide”);
R21=cyclopropyl and R22=5-Cl,
R21=ethyl and R22=H,
R21=isopropyl and R22=5-Cl and
R21=isopropyl and R22=H (4-isopropylaminocarbonyl-N-(2-methoxy-benzoyl)benzenesulfonamide);
r) compounds of the formula (S5),

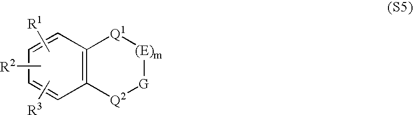

as described in WO-A 98/13 361,
including the stereoisomers and the salts normally used in agriculture.

The safeners listed above are known, for example from “The Pesticide Manual”, 12th edition (2000), 13th edition (2003) and 14th edition (2006), The British Crop Protection Council, or from the literature references given after the individual active compounds.

Preference is given to safeners such as mefenpyr-diethyl, cloquintocet-mexyl, isoxadifen-ethyl, cyprosulfamide (4-cyclopropylaminocarbonyl-N-(2-methoxy-benzoyl)benzenesulfonamide), 4-isopropylaminocarbonyl-N-(2-methoxy-benzoyl)benzenesulfonamide or fenchlorazole-ethyl.

A particular embodiment of the formulations according to the invention are mixtures of herbicides and safeners as component b). The weight ratios of herbicide (mixture) to safener generally depend on the application rate of herbicide and the effectiveness of the safener in question and may vary within wide limits, for example in the range of from 200:1 to 1:200, preferably from 100:1 to 1:100, in particular from 20:1 to 1:20.

Fungicides

The agrochemical active compounds may also be fungicides, for example
inhibitors of nucleic acid synthesis, in particular benalaxyl, benalaxyl-M, bupirimate, chiralaxyl, clozylacon, dimethirimol, ethirimol, furalaxyl, hymexazol, metalaxyl, metalaxyl-M, ofurace, oxadixyl, oxolinic acid
inhibitors of mitosis and cell division, in particular benomyl, carbendazim, diethofencarb, fuberidazole, pencycuron, thiabendazole, thiophanate-methyl, zoxamide
inhibitors of the respiratory chain complex I, in particular diflumetorim
inhibitors of the respiratory chain complex II, in particular boscalid, carboxin, fenfuram, flutolanil, furametpyr, mepronil, oxycarboxin, penthiopyrad, thifluzamide
inhibitors of the respiratory chain complex II, in particular azoxystrobin, cyazofamid, dimoxystrobin, enestrobin, famoxadone, fenamidone, fluoxastrobin, cresoxim-methyl, metominostrobin, orysastrobin, pyraclostrobin, picoxystrobin, trifloxystrobin
uncouplers, in particular dinocap, fluazinam
inhibitors of ATP production, in particular fentin acetate, fentin chloride, fentin hydroxide, silthiofam
inhibitors of amino acid and protein biosynthesis, in particular andoprim, blasticidin-S, cyprodinil, kasugamycin, kasugamycin hydrochloride hydrate, mepanipyrim, pyrimethanil
inhibitors of signal transduction, in particular fenpiclonil, fludioxonil, quinoxyfen
inhibitors of lipid and membrane synthesis, in particular chlozolinate, iprodione, procymidone, vinclozolin ampropylfos, ampropylfos potassium, edifenphos, iprobenfos (IBP), isoprothiolane, pyrazophos tolclofos-methyl, biphenyl iodocarb, propamocarb, propamocarb hydrochloride
inhibitors of ergosterol biosynthesis, in particular fenhexamide, azaconazole, bitertanol, bromuconazole, cyproconazole, diclobutrazole, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazole, penconazole, propiconazole, simeconazole, tebuconazole, tetraconazole, triadimefon, triadimenol, triticonazole, uniconazole, voriconazole, imazalil, imazalil sulfate, oxpoconazole, fenarimol, flurprimidol, nuarimol, pyrifenox, triforine, pefurazoate, prochloraz, triflumizole, viniconazole, aldimorph, dodemorph, dodemorph acetate, fenpropimorph, tridemorph, fenpropidin, spiroxamine, naftifine, pyributicarb, terbinafine
inhibitors of cell wall synthesis, in particular benthiavalicarb, bialaphos, dimethomorph, flumorph, iprovalicarb, polyoxins, polyoxorim, validamycin A
inhibitors of melanin biosynthesis, in particular carpropamid, diclocymet, fenoxanil, phthalide, pyroquilon, tricyclazole
resistance inducers, in particular acibenzolar-S-methyl, probenazole, tiadinil
multisite, in particular captafol, captan, chlorothalonil, copper salts, such as: copper hydroxide, copper naphthenate, copper oxychloride, copper sulfate, copper oxide, oxine-copper and Bordeaux mixture, dichlofluanid, dithianon, dodine, dodine free base, ferbam, folpet, fluorfolpet, guazatine, guazatine acetate, iminoctadine, iminoctadine albesilate, iminoctadine triacetate, mancopper, mancozeb, maneb, metiram, metiram zinc, propineb, sulfur and sulfur preparations comprising calcium polysulfide, thiram, tolylfluanid, zineb, ziram
fungicides with unknown mechanism, in particular amibromdol, benthiazole, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat metilsulfate, diphenylamine, ethaboxam, ferimzone, flumetover, flusulfamide, fluopicolide, fluoroimide, hexachlorobenzene, 8-hydroxyquinoline sulfate, irumamycin, methasulfocarb, metrafenone, methyl isothiocyanate, mildiomycin, natamycin, nickel dimethyldithiocarbamate, nitrothal-isopropyl, octhilinone, oxamocarb, oxyfenthiin, pentachlorophenol and salts, 2-phenylphenol and salts, piperalin, propanosine-sodium, proquinazid, pyrrolnitrin, quintozene, tecloftalam, tecnazene, triazoxide, trichlamide, zarilamid and 2,3,5,6-tetrachloro-4-(methylsulfonyl)pyridine, N-(4-chloro-2-nitrophenyl)-N-ethyl-4-methylbenzene-sulfonamide, 2-amino-4-methyl-N-phenyl-5-thiazolecarboxamide, 2-chloro-N-(2,3-dihydro-1,1,3-trimethyl-1H-inden-4-yl)-3-pyridinecarboxamide, 3-[5-(4-chlorophenyl)-2,3-dimethylisoxazolidin-3-yl]pyridine, cis-1-(4-chlorophenyl)-2-(1H-1,2,4-triazol-1-yl)cycloheptanol, 2,4-dihydro-5-methoxy-2-methyl-4-[[[[[1-[3-(trifluoromethyl)phenyl]ethylidene]amino]oxy]methyl]phenyl]-3H-1,2,3-triazol-3-one (185336-79-2), methyl 1-(2,3-dihydro-2,2-dimethyl-1H-inden-1-yl)-1H-imidazole-5-carboxylate, 3,4,5-trichloro-2,6-pyridinedicarbonitrile, methyl 2-[[[cyclopropyl[(4-methoxyphenyl)imino]methyl]thio]methyl]-α-(methoxy-methylene)benzeneacetate, 4-chloro-α-propynyloxy-N-[2-[3-methoxy-4-(2-propynyloxy)phenyl]ethyl]benzeneacetamide, (2S)—N-[2-[4-[[3-(4-chlorophenyl)-2-propynyl]oxy]-3-methoxyphenyl]ethyl]-3-methyl-2-[(methylsulfonyl)amino]-butanamide, 5-chloro-7-(4-methylpiperidin-1-yl)-6-(2,4,6-trifluorophenyl)-[1,2,4]triazolo[1,5-a]pyrimidine, 5-chloro-6-(2,4,6-trifluorophenyl)-N-[(1R)-1,2,2-trimethylpropyl][1,2,4]triazolo[1,5-a]pyrimidine-7-amine, 5-chloro-N-[(1R)-1,2-dimethylpropyl]-6-(2,4,6-trifluorophenyl)[1,2,4]triazolo[1,5-a]pyrimidine-7-amine, N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propyl-benzopyran-4-one, N-{(Z)-[(cyclopropylmethoxy)imino][6-(difluoromethoxy)-2,3-difluorophenyl]methyl}-2-benzeneacetamide, N-(3-ethyl-3,5,5-trimethylcyclo-hexyl)-3-formylamino-2-hydroxybenzamide, 2-[[[[1-[3(1-fluoro-2-phenylethyl)-oxy]phenyl]ethylidene]amino]oxy]methyl]-α-(methoxyimino)-N-methyl-αE-benzeneacetamide, N-{2-[3-chloro-5-(trifluoromethyl)pyridin-2-yl]ethyl}-2-(trifluoromethyl)benzeneamide, N-(3′,4′-dichloro-5-fluorobiphenyl-2-yl)-3-(difluoromethyl)-1-methyl-1H-pyrazole-4-carboxamide, N-(6-methoxy-3-pyridinyl)cyclopropanecarboxamide, 1-[(4-methoxyphenoxy)methyl]-2,2-dimethylpropyl-1H-imidazole-1-carboxylic acid, O-[1-[(4-methoxyphenoxy)-methyl]-2,2-dimethylpropyl]-1H-imidazole-1-carbothioic acid, 2-(2-{[6-(3-chloro-2-methylphenoxy)-5-fluoropyrimidin-4-yl]oxy}phenyl)-2-(methoxyimino)-N-methylacetamide.

The agrochemical active compounds can also be bactericides, for example bronopol, dichlorophen, nitrapyrin, nickel dimethyldithiocarbamate, kasugamycin, octhilinone, furancarboxylic acid, oxytetracycline, probenazole, streptomycin, tecloftalam, copper sulfate and other copper compositions.

The fungicides (bactericides) listed above are, for example, known from “The Pesticide Manual”, 12th edition (2000), 13th edition (2003) and 14th edition (2006), The British Crop Protection Council, or the literature references listed after the individual active compounds.

Preference is given to fungicides such as bitertanol, bromuconazol, carbendazim, carproamid, cyproconazole, edifenphos, fenanidone, fenhexamid, fentins, fluquinconazole, fosetyl aluminum, iprodione, iprovalicarb, pencycuron, prochloraz, propamocarb HCl, propineb, pyrimethanil, spiroxamine, tebuconazole, tolylfluanid-dichlofluanid, triadimefon, triadimenol, trifloxystrobin.

Insecticides

The agrochemical active compounds may also be insecticides/acaricides and/or nematicides, for example
acetylcholinesterase (AChE) inhibitors carbamates, for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate organophosphates, for example acephate, azamethiphos, azinphos (-methyl, -ethyl), bromo-phosethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S-methyl, demeton-S-methylsufone, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, suiprofos, tebupirimfos, temephos, terbufos, tetrachlorvinphos, thiometon, triazophos, trichlorfon, vamidothion
sodium channel modulators/voltage-dependent sodium channel blockers pyrethroides, for example acrinathrin, allethrin (d-cis-trans, d-trans), beta-cyfluthrin, bifenthrin, bioallethrin, bioallethrin-S-cyclopentenyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans-isomer), prallethrin, profluthrin, protrifenbute, pyresmethrin, resmethrin, RU 15525, silafluofen, tau-fluvalinate, tefluthrin, terallethrin, tetramethrin (1R-isomer), tralomethrin, transfluthrin, ZXI 8901, pyrethrins (pyrethrum) DDT oxadiazines, for example indoxacarb semicarbazones, for example metaflumizone (BAS3201)
acetylcholine receptor agonists/antagonists chloronicotinyls, for example acetamiprid, clothianidin, dinotefuran, imidacloprid, nitenpyram, nithiazine, thiacloprid, thiamethoxam nicotine, bensultap, cartap
acetylcholine receptor modulators spinosyns, for example spinosad
GABA-controlled chloride channel antagonists organochlorines, for example camphechlor, chlordane, endosulfan, gamma-HCH, HCH, heptachlor, lindane, methoxychlor fiproles, for example acetoprole, ethiprole, fipronil, pyrafluprole, pyriprole, vaniliprole
chloride channel activators mectins, for example abamectin, emamectin, emamectin benzoate, ivermectin, lepimectin, milbemycin
juvenile hormone mimics, for example diofenolan, epofenonane, fenoxycarb, hydroprene, kinoprene, methoprene, pyriproxyfen, triprene
ecdysone agonists/disruptors diacylhydrazines, for example chromafenozide, halofenozide, methoxyfenozide, tebufenozide
inhibitors of chitin biosynthesis benzoylureas, for example bistrifluron, chlofluazuron, diflubenzuron, fluazuron, flucycloxuron, flufenoxuron, hexaflumuron, lufenuron, novaluron, noviflumuron, penfluron, teflubenzuron, triflumuron buprofezin cyromazine
inhibitors of oxidative phosphorylation, ATP disruptors diafenthiuron organotin compounds, for example azocyclotin, cyhexatin, fenbutatin oxide
uncouplers of oxidative phoshorylation by interruption of the H-proton gradient pyrroles, for example chlorfenapyr dinitrophenols, for example binapacyrl, dinobuton, dinocap, DNOC
Site-I electron transport inhibitors METIs, for example fenazaquin, fenpyroximate, pyrimidifen, pyridaben, tebufenpyrad, tolfenpyrad hydramethylnon dicofol
Site-II electron transport inhibitors rotenone
Site-III electron transport inhibitors acequinocyl, fluacrypyrim
microbial disruptors of the insect gut membrane Bacillus thuringiensis strains
inhibitors of lipid synthesis tetronic acids, for example spirodiclofen, spiromesifen tetramic acids, for example spirotetramat carboxamides, for example flonicamid octopaminergic agonists, for example amitraz
inhibitors of magnesium-stimulated ATPase, propargite nereistoxin analogs, for example thiocyclam hydrogen oxalate or thiosultap-sodium
agonists of the ryanodine receptor, benzoic acid dicarboxamides, for example flubendiamide anthranilamides, for example DPX E2Y45 (3-bromo-N-{4-chloro-2-methyl-6-[(methylamino)carbonyl]phenyl}-1-(3-chloropyridin-2-yl)-1H-pyrazole-5-carboxamide)
biologicals, hormones or pheromones azadirachtin, Bacillus spec., Beauveria spec., codlemone, Metarrhizium spec., Paecilomyces spec., thuringiensin, Verticillium spec.
active compounds with unknown or nonspecific mechanisms of action antifeedants, for example cryolite, flonicamid, pymetrozine mite growth inhibitors, for example clofentezine, etoxazole, hexythiazox amidoflumet, benclothiaz, benzoximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenzimine, flufenerim, flutenzine, gossyplure, hydramethylnon, japonilure, metoxadiazone, petroleum, piperonyl butoxide, potassium oleate, pyridalyl, sulfluramid, tetradifon, tetrasul, triarathene, verbutin.

The insecticides (acaricides, nematicides) listed above are, for example, known from “The Pesticide Manual”, 12th edition (2000), 13th edition (2003) and 14th edition (2006), The British Crop Protection Council, or the literature references listed after the individual active compounds.

Preference is given to insecticides, such as acetamiprid, acrinathrin, aldicarb, amitraz, azinphos-methyl, beta-cyfluthrin, carbaryl, cyfluthrin, cypermethrin, deltamethrin, endosulfan, ethoprophos, fenamiphos, fenthion, imidacloprid, methamidophos, methiocarb, niclosamide, oxydemeton-methyl, phosalone, prothiophos, silafuofen, thiacloprid, thiodicarb, tralomethrin, triazophos, trichlorfon, triflumuron; very particularly preferably from the group of the chloronicotinyls, such as acetamiprid, clothianidin, dinotefuran, imidacloprid, nitenpyram, nithiazine, thiacloprid, thiamethoxam.

Particularly preferred agrochemically active compounds are representatives from the group of the above-defined “sulfonamides”, preferably thiencarbazone(-methyl), flucarbazone, propoxycarbazone, amicarbazone, mesosulfuron, iodosulfuron-methyl(-sodium), ethoxysulfuron, amidosulfuron, foramsulfuron, and also tembotrione, isoxaflutole, diflufenican, flufenacet cyprosulfamide, mefenpyr-diethyl, cloquintocet-mexyl, isoxadifen-ethyl, tebuconazole, fluquinconazole, imidacloprid, thiacloprid, clothianidin, prothioconazol, fluopicolid, fipronil, fluoxastrobin and ethiprole.

In general, the formulations according to the invention comprise from 0.01 to 40% by weight, preferably from 0.1 to 30% by weight, particularly preferably from 5 to 20% by weight, of the (agrochemically) active compounds (component b) from the group of the herbicides, safeners, insecticides and fungicides, where the agrochemical compositions (crop protection compositions) obtainable from the formulations according to the invention may generally comprise from 0.01 to 90% by weight, based on the agrochemical composition, in particular from 0.1 to 80% by weight of the (agrochemically) active compounds (component b) from the group of the herbicides, safeners, insecticides and fungicides. The area-based application rates of the component b) are generally between 1 and 2000 g of AS/ha (AS=active substance, i.e. the application rate based on the active compound), preferably between 2 and 1000 g of AS/ha.

The wetting agents (component c) in the formulations according to the invention may be taken from the group of the nonionic and ionic surfactants and also surfactants on a non-aromatic base.

Suitable nonionic surfactants are, for example, polyalkoxylated, preferably polyethoxylated, saturated or unsaturated aliphatic alcohols,
having from 8 to 24 carbon atoms in the alkyl radical, which is derived from the corresponding fatty acids or from petrochemical products, and
having from 1 to 100, preferably from 2 to 50, ethylene oxide units (EO), where the free hydroxyl group is, is appropriate, alkoxylated;
which are commercially obtainable, for example as ®Genapol X and ®Genapol O series (Clariant), ®Crovol M series (Croda) or ®Lutensol series (BASF);
compounds from the group of the di- and triblock copolymers of alkylene oxides, such as, for example, compounds constructed on the basis of ethylene oxide and propylene oxide, having mean molar masses between 200 and 10 000, preferably from 1000 to 4000, g/mol, where the proportion by mass of the polyethoxylated block varies between 10 and 80%, such as, for example, ®Synperonic PE series (Uniqema), ®Pluronic PE series (BASF), ®VOP 32- or ®Genapol PF series (Clariant) and
nonylphenols, such as, for example, products from the ®Arkopal series (Clariant).

Suitable ionic surfactants are, for example,
polyalkoxylated, preferably polyethoxylated surfactants which are ionically modified, for example by conversion of the terminal free hydroxyl group of the polyethylene oxide block to a sulfate or phosphate ester (for example as alkali metal and alkaline earth metal salts), such as, for example, ®Genapol LRO or dispersant 3618 (Clariant), ®Emulphor (BASF) or ®Crafol AP (Cognis).

Suitable surfactants on a nonaromatic basis are, for example,
sulfosuccinates, alkanesulfonates, paraffin- or olefinsulfonates such as ®Netzer IS, ®Hoe S1728, ®Hostapur OS, ®Hostapur SAS from Clariant, ®Triton GR7ME and GR5 from Union Carbide, ®Empimin products from Albright and Wilson, ®Marlon-PS65 from Condea.
fatty acid amide alkoxylates, such as the ®Comperlan products from Henkel or the ®Amam products from Rhodia. Alkylene oxide adducts of alkynediols, such as the ®Surfynol products from Air Products. Sugar derivatives, such as amino sugars and amido sugars from Clariant, glucitols from Clariant, alkyl polyglycosides in the form of the ®APG products from Henkel or such as sorbitan esters in the form of the ®Span or ®Tween products from Uniquema or cyclodextrin esters or cyclodextrin ethers from Wacker.

Typical representatives of suitable wetting agents are, inter alia, ®Monatrope 1620 (syn. AL 2575, alkyl polyglucosides; Uniqema), ®Atlox 4894 (fatty alcohol ethoxylate, nonylphenol-free, syn. POE alkyl ether; Uniqema), ®Morwet EFW (alkylnaphthalene-sulfonic acid derivative; Akzo Nobel), ®Morwet DB (dibutylnaphthalenesulfonate Na salt; Akzo Nobel), ®Galoryl MT 800 (sodium dibutylnaphthalenesulfonic acid; CFPI-Nufarm) and ®Nekal BX (alkylnaphthalenesulfonate; BASF).

Preference is given here to ®Monatrope 1620 and ®Atlox 4894.

The proportion of wetting agents in the formulations according to the invention (component c) can be from 0.1 to 20% by weight, preferably from 1 to 5% by weight.

The dispersants (component d) in the formulations according to the invention can be taken from the group of the nonionic and ionic surfactants and also surfactants on a nonaromatic basis.

Suitable nonionic surfactants are, for example, polyalkoxylated, preferably polyethoxylated hydroxy fatty acids or glycerides containing hydroxy fatty acids, such as, for example, ricinine or castor oil having a degree of ethoxylation between 10 and 80, preferably from 25 to 40, such as, for example, ®Emulsogen EL series (Clariant) or ®Agnique CSO series (Cognis).

Suitable ionic surfactants are, for example,
alkali metal and alkaline earth metal salts of alkylarylsulfonic acids having a straight-chain or branched alkyl chain, such as phenylsulfonate CA or phenylsulfonate CAL (Clariant), ®Atlox 3377BM (Uniqema), ®Empiphos TM series (Huntsman);
polyelectrolytes, such as lignosulfonates, polystyrenesulfonate or sulfonated unsaturated or aromatic polymers (polystyrenes, polybutadienes or polyterpenes), such as ®Tamol series (BASF), ®Morwet D425 (Witco), ®Kraftsperse series (Westvaco), ®Borresperse series (Borregard).

Suitable surfactants on a nonaromatic basis are, for example,
fatty acid amide alkoxylates, such as the ®Comperlan products from Henkel or the ®Amam products from Rhodia.
alkylene oxide adducts of alkynediols, such as the ®Surfynol products from Air Products. Sugar derivatives, such as amino sugars and amido sugars from Clariant, glucitols from Clariant, alkyl polyglycosides in the form of the ®APG products from Henkel or such as sorbitan esters in the form of the ®Span or ®Tween products from Uniquema or cyclodextrin esters or cyclodextrin ethers from Wacker.
surface-active polyacryl and polymethacryl derivatives, such as the ®Sokalan products from BASF.

Typical representatives of suitable dispersants are, inter alia, ®Dispersogen LFH (tristyrylphenol polyethylene glycol phosphoric acid esters, Clariant), ®Agnique PG series 9116 (alkyl polyglycosides, Cognis) and ®Atlox 4913 (polyoxyethylene/acrylic acid copolymer solution in propylene glycol; Uniqema).

Preference is given here to ®Dispersogen LFH and ®Atlox 4913.

The proportion of dispersants in the formulations according to the invention (component d) can be from 0.1 to 20% by weight, preferably from 1 to 5% by weight.

Suitable antifoams (defoamers, component e) in the formulations according to the invention are, for example, substances based on silicone from Wacker, Rhodia, Dow Corning, and substances based on acetylene, such as, for example, those from Airproducts. Surface-active compounds based on silicone or silane, such as the ®Tegopren products (Goldschmidt), the ®SE products (Wacker) and also the ®Bevaloid, ®Rhodorsil and ®Silcolapse products (Rhodia, Dow Corning, Reliance, GE, Bayer) may be mentioned.

Typical representatives of suitable antifoams are, inter alia, ®Antischaummittel SL and SE2 (Wacker), ®Rhodorsil 481(polydimethylsiloxane/silicic acid, Rhodia), and also the ®Rhodorsil types 432 and 454.

Preference is given here to the ®Rhodorsil types 432, 454 and 481, in particular to ®Rhodorsil 481.

The proportion of antifoams in the formulations according to the invention (component e) can be from 0.02 to 2% by weight, preferably from 0.2 to 1.5% by weight.

Suitable agents for adjusting rheological properties (component f) in the formulations according to the invention are, for example:
modified natural silicates, such as chemically modified bentonite, hectorite, attapulgite, montmorillonite, smectite or other silicate minerals, such as ®Bentone (Elementis), ®Attagel (Engelhard), ®Agsorb (Oil-Dri Corporation) or ®Hectorite (Akzo Nobel),
natural and synthetic silicates, such as silicates of the ®Sipernat, ®Aerosil or ®Durosil series (Degussa), the ®CAB O SIL series (Cabot) or the Van Gel series (R. T. Vanderbilt),
thickeners based on synthetic polymers, such as thickeners of the ®Thixin or ®Thixatrol series (Elementis).

Typical representatives of suitable agents for adjusting rheological properties are, inter alia, natural silicates, such as, for example, kaolin, bentonite, talc, pyrophyllite, diatomaceous earth or alumina (inter alia ®Kaolin 1777 from Ziegler, Wunsiedel; ®Agsorb LVM-GA as attapulgite; ®Harborlite 300 as perlite from Lehmann & Voss; ®Omya chalk as calcium carbonate; earth metal and alkaline earth metal silicates, such as, for example, alumosilicates (inter alia ®Kaolin Tec 1 or ®Kaolin W as aluminum hydrosilicates from Erbslöh) or magnesium silicates (inter alia ®Steamic 00S as talc, magnesium silicate); synthetic silicates, such as, for example, pyrogenic silicic acids or precipitated silicic acids, such as the product series ®Sipernat (inter alia ®Sipernat 50 S or ®Sipernat 500 LS), ®Dessalon, ®Extrusil, ®Aerosil (inter alia ®Aerosil COK 84 or ®Aerosil 200 as silicon dioxide from Degussa), ®Silkasil or ®Ketiensil; products on an organic and/or inorganic base, such as, for example, ®Bentone 38, ®Bentone EW (Elementis) and ®Rhodopol 23 (xanthan derivative, heteropolysaccharides, Rhodia).

Preference is given here to ®Rhodopol 23, ®Aerosil 200 and ®Kaolin W.

The proportion of the agents for adjusting rheological properties in the formulations according to the invention (component f) may be from 0 to 7% by weight, preferably from 0.1 to 4% by weight.

Acids which may be used for adjusting the pH to between 2.5 and 4.5 (component g) in the formulations according to the invention may, in principle, be all suitable acids. Preference is given to polybasic organic acids. Examples of suitable polybasic organic acids are, for example, citric acid, tartaric acid, succinic acid, maleic acid, fumaric acid, etc. Particular preference is given to citric acid, both as crystalline monohydrate and anhydrous.

The proportion of the acids for adjusting the pH to between 2.5 and 4.5 in the formulations according to the invention (component g) may be from 0 to 3% by weight, preferably from 0.3 to 1.5% by weight.

Preservatives (biocides; component h) which may be used in the formulations according to the invention are, in principle, all suitable substances. Examples of suitable preservatives are, for example, from the product series ®Acticide, such as ®Acticide MBS (a mixture of 2-methyl-2H-isothiazol-3-one and 1,2-benzisothiazol-3-(2H)-one, Thor Chemie), ®Mergal, such as ®Mergal WP1 and ®Mergal K9N, and ®Proxel, such as ®Proxel XL2 (sodium salt in water and propylene glycol of 1,2-benzisothiazol-3-(2H)-one, Zeneca) and ®Proxel GXL (aqueous dipropylene glycol solution of about 20% 1,2-benzisothiazoline, Avecia—Frankfurt).

Preference is given here to ®Acticide MBS and ®Proxel GXL.

The proportion of the preservatives in the formulations according to the invention (biocides; component h) can be from 0 to 1% by weight, preferably from 0.05 to 0.4% by weight.

Suitable further formulation auxiliaries (component i) in the formulations according to the invention are, for example, suitable antioxidants, colorants and fragrances, wetting agents, anti-drift agents, tackifiers and penetrants (adjuvants) known to the person skilled in the art. In addition, with respect to the biological activity and/or stability of certain agrochemically active compounds, it may be advantageous to add salts, such as, for example, fertilizers, to the formulations according to the invention.

Preference is given to salts such as, for example, ammonium salts, alkali metal salts or alkaline earth metal salts, particularly preferably NaCl, Na₂SO₄, MgCl₂, NH₄NO₃ and ammonium sulfate, in particular ammonium sulfate, where the quality may vary from ‘technical grade’ to ‘highly pure’.

The proportion of the further formulation auxiliaries in the formulations according to the invention (component i) may be from 0 to 30% by weight, preferably from 5 to 15% by weight.

Examples of further surfactants (component j) in the formulations according to the invention different from components c) and d) are listed below, where EO=ethylene oxide units, PO=propylene oxide units and BO=butylene oxide units:
1) C₁-C₂₄-alcohols which may be alkoxylated, for example with 1-60 alkylene oxide units, preferably 1-60 EO and/or 1-30 PO and/or 1-15 BO, in any desired order. The terminal hydroxyl groups of these compounds may be end-capped by an alkyl, cycloalkyl or acyl radical having 1-24 carbon atoms. Examples of such compounds are: ®Genapol C, L, O, T, UD, UDD, X products from Clariant, ®Plurafac and ®Lutensol A, AT, ON, TO products from BASF, ®Marlipal 24 and O13 products from Condea, ®Dehypon products from Henkel, ®Ethylan products from Akzo-Nobel such as ®Ethylan CD 120.
2) Anionic derivatives of the products described under 1), in the form of ether carboxylates, sulfonates, sulfates and phosphates and their inorganic salts (for example alkali metal and alkaline earth metal salts) and organic salts (for example based on amines or alkanolamines) such as ®Genapol LRO, ®Sandopan products, ®Hostaphat/Hordaphos products from Clariant. Copolymers consisting of EO, PO and/or BO units such as, for example, block copolymers such as the ®Pluronic products from BASF and the ®Synperonic products from Uniquema with a molecular weight of from 400 to 10⁸. Alkylene oxide adducts of C₁-C₉-alcohols such as ®Atlox 5000 from Uniquema or ®Hoe-S3510 from Clariant.
   Typical further representatives are, inter alia, also ®Galoryl MT 804 (dibutylnaphthalenesulfonate Na salt) from Nufam, ®Geropon T 36 (Na polycarboxylic acid), ®Supragil MNS 90 (methylnaphthalenesulfonic acid Na salt condensation product) from Rhodia and ®Darvan No 3 (Na polymer-substituted benzoidalalkylsulfonates) from Vanderbuilt which can be used as dispersant, as well as ®Geronol CF/AR (NH₄ salt phosphoric ester of ethoxylated alcohols) and ®Supragil WP (Na diisopropylnaphthalene sulfonate) from Rhodia which can be used as wetting agent.
3) Fatty acid and triglyceride alkoxylates such as the ®Serdox NOG products from Condea or alkoxylated vegetable oils such as soya oil, rapeseed oil, corn oil, sunflower oil, cottonseed oil, linseed oil, coconut oil, palm oil, safflower oil, walnut oil, peanut oil, olive oil or castor oil, in particular rapeseed oil, vegetable oils also being understood as encompassing their transesterification products, for example alkyl esters such as rapeseed oil methyl ester or rapeseed oil ethyl ester, for example the ®Emulsogen products from Clariant, salts of aliphatic, cycloaliphatic and olefinic carboxylic acids and polycarboxylic acids, and alpha-sulfo-fatty acid esters such as those available from Henkel.
4) Fatty acid amide alkoxylates such as the ®Comperlan products from Henkel or the ®Amam products from Rhodia.
   Alkylene oxide adducts of alkynediols such as the ®Surfynol products from Air Products. Sugar derivatives such as amino sugars and amido sugars from Clariant, glucitols from Clariant, alkylpolyglycosides in the form of the ®APG products from Henkel or such as sorbitan esters in the form of the ®Span or ®Tween products from Uniquema or cyclodextrin esters or cyclodextrin ethers from Wacker. A typical representative here is also, inter alia, ®Atplus 435 (alkylpolyglycoside alkylpolysaccharide mixture) from ICI which can be used by way of example as wetting agent.
5) Surface-active cellulose and algin, pectin and guar derivatives such as the ®Tylose products from Clariant, the ®Manutex products from Kelco and guar derivatives from Cesalpina.
   Polyol-based alkylene oxide adducts, such as ®Polyglykol products from Clariant. Surface-active polyglycerides and their derivatives from Clariant.
6) Sulfosuccinates, alkanesulfonates, paraffin- and olefinsulfonates such as ®Netzer IS, ®Hoe S1728, ®Hostapur OS, ®Hostapur SAS from Clariant, ®Triton GR7ME and ®GR5 from Union Carbide, ®Empimin products from Albright and Wilson, ®Marlon-PS65 from Condea.
7) Sulfosuccinamates such as the ®Aerosol products from Cytec or the ®Empimin products from Albright and Wilson.
8) Alkylene oxide adducts of fatty amines, quaternary ammonium compounds having 8 to 22 carbon atoms (C₈-C₂₂) such as, for example, the ®Genamin C, L, O, T products from Clariant.
9) Surface-active zwitterionic compounds such as taurides, betaines and sulfobetaines in the form of ®Tegotain products from Goldschmidt, ®Hostapon T and ®Arkopon T products from Clariant.
10) Silicone- or silane-based surface-active compounds such as the ®Tegopren products from Goldschmidt and the ®SE products from Wacker, and also the ®Bevaloid, ®Rhodorsil and ®Silcolapse products from Rhodia (Dow Corning, Reliance, GE, Bayer).
11) Perfluorinated or polyfluorinated surface-active compounds such as ®Fluowet products from Clariant, the ®Bayowet products from Bayer, the ®Zonyl products from DuPont and products of this type from Daikin and Asahi Glass.
12) Surface-active sulfonamides, for example from Bayer.
13) Surface-active polyacrylic and polymethacrylic derivatives such as the ®Sokalan products from BASF.
14) Surface-active polyamides such as modified gelatins or derivatized polyaspartic acid from Bayer, and their derivatives.
15) Surfactant polyvinyl compounds such as modified polyvinylpyrrolidone, such as the ®Luviskol products from BASF and the ®Agrimer products from ISP or the derivatized polyvinyl acetates such as the ®Mowilith products from Clariant or the polyvinyl butyrates such as the ®Lutonal products from BASF, the ®Vinnapas and the ®Pioloform products from Wacker or modified polyvinyl alcohols such as the ®Mowiol products from Clariant.
16) Surface-active polymers based on maleic anhydride and/or reaction products of maleic anhydride, and copolymers comprising maleic anhydride and/or reaction products of maleic anhydride, such as ®Agrimer-VEMA products from ISP.
17) Surface-active derivatives of montan, polyethylene and polypropylene waxes such as the ®Hoechst waxes or the ®Licowet products from Clariant.
18) Surface-active phosphonates and phosphinates such as ®Fluowet-PL from Clariant.
19) Polyhalogenated or perhalogenated surfactants such as, for example, ®Emulsogen-1557 from Clariant.
20) Compounds which formally constitute the reaction products of the aforementioned phenols with sulfuric acid or phosphoric acid and their salts which have been neutralized with suitable bases, for example the acid phosphoric ester of triethoxylated phenol, the acid phosphoric ester of a nonylphenol reacted with 9 mol of ethylene oxide, and the triethanolamine-neutralized phosphoric ester of the reaction product of 20 mol of ethylene oxide and 1 mol of tristyrylphenol.
21) Benzenesulfonates such as alkyl- or arylbenzenesulfonates, for example acid (poly)alkyl- and (poly)arylbenzenesulfonates and those neutralized with suitable bases, for example having 1 to 12 carbon atoms per alkyl radical and/or up to 3 styrene units in the polyaryl radical, preferably (linear) dodecylbenzenesulfonic acid and its oil-soluble salts such as, for example, the calcium salt, or the isopropylammonium salt of dodecylbenzenesulfonic acid.

Preferred among the alkyleneoxy units are ethyleneoxy, propyleneoxy and butyleneoxy units, particularly ethyleneoxy units.

Examples of surfactants from the group of the nonaromatic-based surfactants are the surfactants of the above groups 1) to 19), preferably of the groups 1), 2), 6), and 8).

Examples of surfactants from the group of the aromatic-based surfactants are the surfactants of the abovementioned groups 20) and 21), preferably phenol which has been reacted with 4 to 10 mol of ethylene oxide, commercially available for example in the form of the ®Agrisol products (Akcros), nonylphenol which has been reacted with 4 to 50 mol of ethylene oxide, commercially available for example in the form of the ®Arkopal products (Clariant), tristyrylphenol which has been reacted with 1 to 50 mol of ethylene oxide, for example from the ®Soprophor series (Rhodia) such as ®Soprophor FL, ®Soprophor 4D-384, and

acid (linear) dodecylbenzenesulfonate, commercially available for example in the form of the ®Marlon products (Hüls).

The proportion of further surfactants in the formulations according to the invention (component j) may be from 0 to 10% by weight.

The further solvents (component k) in the formulations according to the invention may, in addition to water, be from the groups of the
organic solvents, such as, for example, gamma-butyrolactone, pyrrolidones, such as, for example, N-methylpyrrolidone (NMP), N-butylpyrrolidone, N-octylpyrrolidone (®Agsol EX 8), N-dodecylpyrrolidone and N-cyclohexylpyrrolidone, acetophenone, ®Solvesso ND, 200, etc.;
aliphatic solvents, such as, for example, ®Genagen 4166 (N,N-dimethyl fatty acid amide), ®Highsolv A (acetal), hexanol, propylene carbonate, ®Highso;
solvents on a vegetable base, such as, for example, ®Edenor Mesu (rapeseed oil methyl ester).

Preferred as further solvent is water, where the quality may vary from tap water to deionized water to distilled water.

The proportion of the further solvents, preferably water, in the formulations according to the invention (component k) is generally from 0 to 30% by weight, preferably from 0 to 20% by weight, particularly preferably from 0 to 13% by weight.

Both the use of the individual components and their content in the formulations according to the invention may be varied within a relatively wide range.

The invention furthermore relates to an agrochemical composition which can be prepared from the formulations according to the invention by dilution with liquids, preferably water.

The formulations according to the invention can be applied, for example, in the preparation forms customary for liquid preparations, either as such or after prior dilution, for example with water, i.e., for example, as emulsions, suspensions or solutions. Here, application is carried out by customary methods, i.e., for example, by spraying, watering or injecting.

It may be advantageous to add to the agrochemical compositions (spray liquors) obtained in this manner further active compounds, preferably agrochemically active compounds (for example as tank mix partners in the form of corresponding formulations), and/or auxiliaries and additives customary for application, for example adjuvants, such as, for example, self-emulsifying oils, such as vegetable oils or paraffin oils and/or fertilizers. Accordingly, the present invention also provides agrochemical compositions prepared in this manner.

For application, all methods known to the person skilled in the art as being customary may be used; examples which may be mentioned are: spraying, dipping, atomizing, and also a number of special methods for direct below-ground or above-ground treatment of entire plants or parts (seed, root, stolons, stems, trunks, leaf), such as, for example, trunk injection in the case of trees or stem bandages in the case of perennial plants, and a number of special indirect application methods.

The respective rates of the agrochemical compositions applied per unit area and/or subject for the control of the harmful organisms mentioned vary very greatly. In general, for this, the application media known to the person skilled in the art as conventional for the respective field of use are employed in conventional amounts, such as, for example, from several hundred liters of water per hectare with standard spray methods to a few liters of oil per hectare with the ultra low volume aircraft application down to a few milliliters of a physiological solution with injection methods. The concentration of the crop protection compositions according to the invention in the respective application media thus vary within a wide range and depend on the area of use in question. In general, the concentrations used are known to the person skilled in the art as being customary for the area of use in question. Preferred concentrations are from 0.01% by weight to 99% by weight, particularly preferably from 0.1% by weight to 90% by weight.

The application rate of the formulations according to the invention can be varied within a relatively wide range. It depends on the respective agrochemically active compounds and their content in the formulations.

Particular embodiments of the invention relate to the use of the formulations according to the invention and the agrochemical compositions obtainable therefrom for controlling unwanted harmful organisms, excluding therapeutic applications in humans and animals, with simultaneous excellent crop plant compatibility, i.e. high selectivity, hereinbelow referred to as “fungicidal composition” or “insecticidal composition”, where the term “fungicidal composition” comprises both compositions against fungi (fungicides) and against bacteria (bactericides) and the term “insecticidal composition” comprises both compositions against insects (insecticides) and against arachnids (acaricides), nematodes (nematicides), molluscs (molluscicides), rodents (rodenticides) and also repellents—unless indicated otherwise by the context.

A particular embodiment of the invention relates to the use of agrochemical compositions obtainable from the formulations according to the invention for controlling unwanted vegetation (harmful plants), with simultaneous excellent crop plant compatibility, i.e. high selectivity, hereinbelow referred to as “herbicidal composition”, where the term “herbicidal composition” embraces both compositions against weeds (herbicides), for regulating plant growth (plant growth regulators), for protecting crop plants (safeners) and for nutrition (plant nutrients), and also substances having systemic properties, and also contact agents suitable as combination partners—unless indicated otherwise by the context.

Further particular embodiments of the invention relate to processes for controlling unwanted harmful organisms where the formulations according to the invention or the agrochemical compositions obtainable therefrom are applied in an effective amount to the harmful organisms or to their habitat, methods for the therapeutic application in humans and animals being excluded.

The herbicidal compositions have outstanding herbicidal activity against a broad spectrum of economically important monocotyledonous and dicotyledonous harmful plants. Even perennial weeds which produce shoots from rhizomes, rootstocks or other perennial organs and which are difficult to control are controlled well. In this context, it does not matter whether the herbicidal compositions are applied before sowing, pre-emergence or post-emergence. Specific examples may be mentioned of some representatives of the monocotyledonous and dicotyledonous weed flora which can be controlled by the herbicidal compositions, without the enumeration being a restriction to certain species.

Examples of weed species on which the herbicidal compositions act efficiently are, from amongst the monocotyledonous weed species, Apera spica venti, Avena spp., Alopecurus spp., Brachiaria spp., Digitaria spp., Lolium spp., Echinochloa spp., Panicum spp., Phalaris spp., Poa spp., Setaria spp. and Bromus spp. such as Bromus catharticus, Bromus secalinus, Bromus erectus, Bromus tectorum and Bromus japonicus, and Cyperus species from the annual group, and, among the perennial species, Agropyron, Cynodon, Imperata and Sorghum and also perennial Cyperus species. In the case of the dicotyledonous weed species, the spectrum of action extends to genera such as, for example, Abutilon spp., Amaranthus spp., Chenopodium spp., Chrysanthemum spp., Galium spp. such as Galium aparine, Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., among the annuals, and Convolvulus, Cirsium, Rumex and Artemisia in the case of the perennial weeds.

The herbicidal compositions also act outstandingly efficiently on harmful plants which are found under the specific culture conditions in rice, such as, for example, Echinochloa, Sagittaria, Alisma, Eleocharis, Scirpus and Cyperus.

If the herbicidal compositions are applied to the soil surface before germination, the weed seedlings are either prevented completely from emerging or else the weeds grow until they have reached the cotyledon stage, but then their growth stops, and, eventually, after three to four weeks have elapsed, they die completely.

If the herbicidal compositions are applied post-emergence to the green parts of the plants, growth likewise stops drastically a very short time after the treatment, and the weed plants remain at the growth stage of the point of time of application, or they die completely after a certain time, so that in this manner competition by the weeds, which is harmful to the crop plants, is eliminated very early and in a sustained manner.

The herbicidal compositions are distinguished by a rapidly commencing and long-lasting herbicidal action. As a rule, the rainfastness of the active substances in the herbicidal compositions is advantageous. A particular advantage is that the dosages used in the herbicidal compositions and the effective dosages of herbicidal compounds can be adjusted to such a low level that their soil action is optimally low. This does not only allow them to be employed in sensitive crops in the first place, but groundwater contaminations are virtually avoided. The active compound combination according to the invention allows the required application rate of the active substances to be reduced considerably.

The abovementioned properties and advantages are necessary for weed control practice to keep agricultural crops free from undesired competing plants, and thus to ensure and/or increase yield levels from the qualitative and quantitative angle. These novel herbicidal compositions markedly exceed the technical state of the art with a view to the properties described.

While the herbicidal compositions have an outstanding herbicidal activity against monocotyledonous and dicotyledonous weeds, crop plants of economically important crops, for example dicotyledonous crops such as soya, cotton, oilseed rape, sugarbeet, or graminaceous crops such as wheat, barley, rye, oats, millet, rice or corn, are damaged only to a minor extent, if at all. This is why the present herbicidal compositions are highly suitable for the selective control of undesired plant growth in plantations of agricultural crops or of ornamentals.

In addition, the corresponding herbicidal compositions have outstanding growth-regulatory properties in crop plants. They engage in the plants' metabolism in a regulatory manner and can thus be employed for provoking direct effects on plant constituents and to facilitate harvesting such as, for example, by triggering desiccation and stunted growth. Moreover, they are also suitable for the general control and inhibition of undesired vegetative growth without simultaneously destroying the plants. Inhibition of vegetative growth is very important in a large number of monocotyledonous and dicotyledonous crops since lodging can thus be reduced, or prevented completely.

Owing to their herbicidal and plant-growth-regulatory properties, the herbicidal compositions can also be employed for controlling harmful plants in crops of genetically modified plants which are known or yet to be developed. As a rule, the recombinant plants are distinguished by specific advantageous characteristics, for example by resistances to certain pesticides, in particular certain herbicides, resistances to plant diseases or the causative organisms of plant diseases such as specific insects or microorganisms such as fungi, bacteria or viruses. Other specific characteristics relate, for example, to the harvested material with regard to quantity, quality, storability, composition and specific constituents. Thus, for example, transgenic plants are known whose starch content is increased, or whose starch quality is altered, or those where the harvested material has a different fatty acid composition.

The use of the herbicidal compositions in economically important transgenic crops of useful plants and ornamentals, for example of graminaceous crops such as wheat, barley, rye, oats, millet, rice and corn, or else crops of sugarbeet, cotton, soya, oilseed rape, potatoes, tomatoes, peas and other vegetables, is preferred. Preferably, the herbicidal compositions can be employed in crops of useful plants which resist the phytotoxic effects of the herbicides, or have been made to resist these effects by recombinant techniques.

When using the herbicidal compositions in transgenic crops, effects are frequently observed in addition to the effects against harmful plants to be observed in other crops, which are specific for the application in the transgenic crop in question, for example a modified or specifically widened weed spectrum which can be controlled, modified application rates which may be employed for application, preferably good combining ability with the further herbicidally active compounds to which the transgenic crop is resistant, and an effect on growth and yield level of the transgenic crop plants.

The present invention therefore also relates to a method for controlling undesired vegetation (harmful plants), preferably in crops of plants such as cereals (for example wheat, barley, rye, oats, rice, corn and millet), sugar beet, sugar cane, oilseed rape, cotton and soya, especially preferably in monocotyledonous plants such as cereals, for example wheat, barley, rye, oats, and their hybrids such as triticale, rice, corn and millet, wherein the formulations according to the invention or the herbicidal compositions obtainable therefrom are applied to the harmful plants, plant parts, seeds of the plants or the area on which the plants grow, for example the area under cultivation, in an effective amount.

The plant crops may also be genetically modified or have been obtained by mutation selection; they preferably tolerate acetolactate synthase (ALS) inhibitors.

The plants treated according to the invention are, as far as the use of herbicides is concerned, all types of harmful plants, such as weeds. With respect to the protection of crop plants by application of, for example, fungicides and insecticides, the use in economically important crops including, for example, also transgenic crops, of useful plants and ornamentals, for example of cereals, such as wheat, barley, rye, oats, millet, rice, manioc and corn, or else crops of peanut, sugar beet, cotton, soybean, oilseed rape, potato, tomato, pea and other vegetable species, is preferred.

The process for preparing the formulations according to the invention can be chosen from a number of processes known per se which describe the preparation of suspension concentrates. From among these, preference is given to the processes where grinding takes place in a toothed colloid mill, if appropriate with fine grinding in a bead mill. In all processes, the individual components are combined in the respective ratios resulting from the preparation, where in each case glycerol is initially charged in an amount of from 60 to 90% by weight, preferably from 70 to 85% by weight, based on the total weight of the formulation.

The formulations according to the invention have excellent chemical and physical stability during preparation and storage and are suitable in particular also for combinations of active compounds having different physicochemical properties. Overall, the formulations according to the invention have the long-term storage stability desired and are without fault from a technical point of view.

### EXAMPLES

The examples are meant to illustrate the invention and do not limit it to the processes and compounds described therein.

Preparation process (for example Example 3, Table 1):

glycerol (component a) is initially charged in a vessel fitted with a stirrer, and the stirrer is started. All further liquid components are added, component(s) b) being added last. The product is then pre-ground using a toothed colloid mill, passing through the mill gap at the smallest setting. This is followed by fine grinding on a bead mill (glass beads having a diameter of 1 mm) until the particle size distribution is d50=1.3-3.5μ. Component f) is then stirred into the ground suspension using an Ystral-Dispermix. The pH is then adjusted to pH 3 using citric acid, and the wet sieve residue is checked.

Method for testing the storage stability (for example Examples 4 and 5, Table 2):

The test for determining the storage stability is carried out by storing 5-5000 g samples of the formulations according to the invention at the temperatures and storage times stated in Table 2. After this storage, the active compound analysis is carried out by HPLC methods known to the person skilled in the art.

Description of the commercial products used in the text and in the examples:

| | |
|---|---|
| glycerol 99% | (a) Solvent according to the invention |
| strength | |
| (1,2,3-propanetriol) | |
| glycol 99% strength | Alternative of the prior art to the solvent |
| (1,2-propanediol) | according to the invention, for a comparative test |
| thiencarbazone | (b) Active compound (triazolo herbicide), Bayer |
| (-methyl) | CropScience |
| tembotrione | (b) Active compound (benzoylcyclohexanedione |
| | herbicide), Bayer CropScience |
| isoxaflutole | (b) Active compound (isoxazole herbicide), Bayer |
| | CropScience |
| isoxadifen-ethyl | (b) Active compound (herbicide safener), Bayer |
| | CropScience |
| cyprosulfamide | (b) Active compound (herbicide safener), Bayer |
| | CropScience |
| ® Monatrope 1620 | (c) Wetting agent (alkyl polyglucosides), Uniqema |
| (syn. AL 2575) | |
| ® Atlox 4894 | (c) Wetting agent (fatty alcohol ethoxylate, nonyl- |
| | phenol-free, syn. POE-alkyl ether), Uniqema |
| ® Dispersogen LFH | (d) Dispersant (tristyrylphenol polyethylene glycol |
| | phosphoric acid ester), Clariant |
| ® Atlox 4913 | (d) Dispersant (polyoxyethylene/acrylic acid |
| | copolymer solution in propylene glycol), Uniqema |
| ® Rhodorsil 481 | (e) Antifoam (polydimethylsiloxane/silicic acid), |
| | Rhodia |
| ® Rhodopol 23 | (f) Agent for adjusting rheological properties |
| | (xanthan derivatives, heteropolysaccharide), Rhodia |
| ® Aerosil 200 | (f) Agent for adjusting rheological properties |
| | (silicon dioxide), Degussa |
| ® Kaolin W | (f) Agent for adjusting rheological properties |
| | (aluminum hydrosilicate), Erbslöh |
| citric acid | (g) Acid for adjusting the pH to between 2.5 and 4.5 |
| ® Proxel GXL | (h) Preservative (sodium salt of 1,2-benzisothiazol- |
| | 3-(2H)-one), Zeneca |
| ® Acticide MBS | (h) Preservative (mixture of 2-methyl-2H-isothiazol- |
| | 3-one and 1,2-benzisothiazol-3-(2H)-one), |
| | Thor Chemie |
| ammonium sulfate | (i) Further formulation auxiliaries (fertilizer salt) |
| (technical grade) | |
| water (deionized) | (k) Further solvent |

TABLE 1
Examples 1-4 (according to the invention) and 5 (prior art, analogously to
US 2002/0065198 A1)

| | | Example 1 | Example 2 | Example 3 | Example 4 | Example 5 |
|---|---|---|---|---|---|---|
| Component | Name | [% by wt.] | [% by wt.] | [% by wt.] | [% by wt.] | [% by wt.] |
| (a) | glycerol 99% | 74.38 | 76.26 | 75.00 | 75.50 | — |
| | strength (1,2,3- | | | | | |
| | propanetriol) | | | | | |
| Alternatively | glycol 99% strength | — | — | — | — | 86.80 |
| to | (1,2-propanediol) | | | | | |
| (a) | | | | | | |
| (b) | thiencarbazone | — | 0.79 | 1.64 | 1.62 | 1.67 |
| | (-methyl) | | | | | |
| (b) | tembotrione | 3.49 | 3.96 | — | — | — |
| (b) | isoxaflutole | — | — | 4.13 | 4.14 | 4.17 |
| (b) | isoxadifen-ethyl | 1.74 | — | — | — | — |
| (b) | cyprosulfamide | — | 1.07 | 2.73 | 2.74 | 2.82 |
| (c) | ® Monatrope 1620 | 1.00 | 1.00 | — | — | — |
| (c) | ® Atlox 4894 | — | — | 1.00 | 1.00 | 1.00 |
| (d) | ® Dispersogen LFH | 3.00 | 3.00 | — | — | — |
| (d) | ® Atlox 4913 | — | — | 3.00 | 3.00 | 3.00 |
| (e) | ® Rhodorsil 481 | 0.20 | 0.20 | 0.20 | — | 0.25 |
| (f) | ® Rhodopol 23 | 0.20 | 0.15 | — | — | — |
| (f) | ® Aerosil 200 | 0.10 | 0.10 | — | — | — |
| (f) | ® Kaolin W | — | — | 3.50 | — | — |
| (g) | citric acid | 0.00¹⁾ | 0.00¹⁾ | 0.40²⁾ | — | — |
| (h) | ® Proxel GXL | 0.10 | 0.10 | 0.07 | — | — |
| (h) | ® Acticide MBS | — | — | — | 0.25 | 0.25 |
| (i) | ammonium sulfate | 7.93 | 5.31 | — | — | — |
| | (technical grade) | | | | | |
| (k) | water (deionized) | ad. 100 | ad. 100 | ad. 100 | ad. 100 | ad. 100 |

Note:
¹⁾citric acid - monohydrate cryst.;
²⁾citric acid - anhydrous

Table 1 shows examples of the compositions of formulations according to the invention (Examples 1-4), where Example 5 has a composition analogously to the prior art. The effect on storage stability is shown in Table 2.

TABLE 2
Storage stability of Examples 4 (according to the invention) and 5 (prior art)

| | | Active compound content (% degradation) at a | | | |
|---|---|---|---|---|---|
| | | storage time and temperature of: | | | |
| | | 0 days | 4 weeks at | 8 weeks at | 2 weeks at |
| | | [% by | 40° C. [% by | 40° C. [% by | 54° C. [% by |
| Example | Active compound | wt.] | wt.] | wt.] | wt.] |
| 4 | thiencarbazone | 1.62 | 1.54 (−5%) | 1.54 (−5%) | 1.30 (−20%) |
| (according | (-methyl) | | | | |
| to the | isoxaflutole | 4.14 | 4.03 (−3%) | 4.07 (−2%) | 4.05 (−2%) |
| invention) | cyprosulfamide | 2.74 | 2.71 | 2.75 | 2.79 |
| 5 | thiencarbazone | 1.67 | 1.53 (−8%) | 1.54 (−8%) | 1.05 (−37%) |
| (prior art) | (-methyl) | | | | |
| | isoxaflutole | 4.17 | 3.56 (−15%) | 3.19 (−24%) | 1.83 (−56%) |
| | cyprosulfamide | 2.82 | 2.75 | 2.89 | 2.75 |

The results in Table 2 show clearly and surprisingly, that, with a view to the general storage stability of the active compounds, the formulations according to the invention (with glycerol as component a) are superior to the formulations of the prior art (with glycol as an alternative to component a).

1. An active compound suspension, comprising:
(a) at least 60% by weight of glycerol,
(b) at least one agrochemically active compound,
(c) at least one wetting agent,
(d) at least one dispersant,
(e) at least one antifoam,
and
(f) optionally at least one agent for adjusting rheological properties,
(g) optionally an acid for adjusting the pH to from 2.5 to 4.5,
(h) optionally a preservative biocide,
(i) optionally a further formulation auxiliary,
(j) optionally a further surfactant,
(k) optionally a further solvent.

2. The active compound suspension as claimed in claim 1, comprising:
(a) from 60 to 90% by weight of glycerol,
(b) from 0.1 to 30% by weight of an agrochemically active compounds,
(c) from 0.1 to 20% by weight of a wetting agent,
(d) from 0.1 to 20% by weight of a dispersant,
(e) from 0.02 to 2% by weight of an antifoam,
(f) from 0 to 7% by weight of an agent for adjusting rheological properties,
(g) from 0 to 3% by weight of an acid for adjusting the pH to from 2.5 to 4.5,
(h) from 0 to 1% by weight of a preservative biocide (biocides),
(i) from 0 to 30% by weight of further formulation auxiliary,
(j) from 0 to 10% by weight of a further surfactant,
(k) from 0 to 30% by weight of a further solvent.

3. The active compound suspension as claimed in claim 1, comprising:
(a) from 65 to 85% by weight of glycerol,
(b) from 0.1 to 2% by weight of sulfonamide herbicide,
(b) from 1 to 10% by weight of herbicide,
(b) from 0.5 to 8% by weight of safener,
(b) from 0.5 to 8% by weight of safener,
(c) from 0.1 to 8% by weight of wetting agent,
(d) from 0.3 to 15% by weight of dispersant,
(e) from 0.1 to 2% by weight of antifoam,
(f) from 0.05 to 3% by weight of an agent for adjusting rheological properties,
(f) from 0.05 to 3% by weight of an agent for adjusting rheological properties,
(g) from 0 to 2% by weight of acids for adjusting the pH to from 2.5 to 4.5,
(h) from 0 to 1% by weight of a preservative biocide,
(i) from 2 to 10% by weight of a further formulation auxiliary,
(k) from 0 to 13% by weight of a further solvent.

4. The active compound suspension as claimed in claim 1, comprising:
(a) from 75 to 90% by weight of glycerol,
(b) from 0.5 to 3% by weight of sulfonamide herbicide,
(b) from 1 to 10% by weight of herbicide,
(b) from 0.5 to 10% by weight of safener,
(c) from 0.1 to 8% by weight of wetting agent,
(d) from 0.3 to 15% by weight of dispersant,
(e) from 0 to 2% by weight of antifoam,
(f) from 0 to 7% by weight of an agent for adjusting rheological properties,
(g) from 0 to 2% by weight of an acid for adjusting the pH to from 2.5 to 4.5,
(h) from 0 to 1% by weight of a preservative biocide,
(h) from 0 to 1% by weight of a preservative biocide,
(k) from 0 to 13% by weight of a further solvent.

5. A process for preparing an active compound suspension as claimed in claim 1, which comprises combining individual components, wherein glycerol is initially charged in an amount of from 60 to 90% by weight based on the total weight of the suspension.

6. An agrochemical composition comprising an active compound suspension as claimed in claim 1.

7. An aqueous agrochemical composition obtainable by diluting an active compound suspension as claimed in claim 1.

8. A method for controlling harmful organisms, which comprises applying an active compound suspension as claimed in claim 1 to a harmful organism or to a habitat thereof with the proviso that methods for the therapeutic application in humans and animals are excluded.

9. An active compound suspension as claimed in claim 1 for controlling harmful organisms with the proviso that a therapeutic application in humans and animals is excluded.

10. A herbicidal composition comprising an active compound suspension as claimed in claim 1 wherein said active compound is a herbicide and/or a safener.

11. An aqueous herbicidal composition obtainable by diluting an active compound suspension as claimed in claim 1.

12. A method for controlling unwanted vegetation comprising applying an active compound suspension as claimed in claim 1 to a harmful plant, part of a plant, a plant seed and/or an area on which plants grow.

13. An active compound suspension as claimed in claim 1 for controlling unwanted vegetation.
